(19) United States
(12) Patent Application Publication
(10) Pub. No.: US 2025/0321320 A1
(43) Pub. Date: Oct. 16, 2025

(54) POWER CONTROL AND BEAM MANAGEMENT FOR COMMUNICATION AND SENSING

(71) Applicant: Samsung Electronics Co., Ltd., Suwon-si (KR)

(72) Inventors: Jeongho Jeon, San Jose, CA (US); Haichuan Ding, Casselberry, FL (US); Ebrahim MolavianJazi, Santa Clara, CA (US); Joonyoung Cho, Portland, OR (US)

(21) Appl. No.: 19/251,745

(22) Filed: Jun. 26, 2025

Related U.S. Application Data
(63) Continuation of application No. 17/806,883, filed on Jun. 14, 2022.
(60) Provisional application No. 63/238,464, filed on Aug. 30, 2021.

(51) Int. Cl. G01S 7/40; G01S 13/66; H04B 7/06; H04B 17/309

(52) U.S. Cl. CPC G01S 7/40; G01S 13/66; H04B 7/0617; H04B 7/0626; H04B 17/309

(57) ABSTRACT

Methods and apparatuses for power control and beam management to enable coexistence of radar sensing and wireless communication. A method for a UE includes determining a sensing category or characteristics for a sensing application, and selecting a spatial filter for radar sensing transmission or reception based on determined sensing category or characteristics. The method further includes identifying a radar sensing transmission power and transmitting or receiving radar sensing signals using the spatial filter and the identified radar sensing transmission power. The method further includes reporting one of communication blockage, radar sensing beam information, or CSI adapted to the radar sensing beam information to a base station or neighboring UEs.

### CROSS-REFERENCE TO RELATED APPLICATION AND CLAIM OF PRIORITY

This application is a continuation of U.S. Non-Provisional patent application Ser. No. 17/806,883 filed Jun. 14, 2022, and claims priority to U.S. Provisional Patent Application No. 63/238,464 filed Aug. 30, 2021. The content of the above-identified patent document(s) is incorporated herein by reference.

### TECHNICAL FIELD

The present disclosure relates generally to radar sensing in communications equipment, and more specifically to coexistence of radar sensing and wireless communications, particularly as relates to power control and beam management.

### BACKGROUND

To meet the demand for wireless data traffic having increased since deployment of 4th Generation (4G) or Long Term Evolution (LTE) communication systems and to enable various vertical applications, efforts have been made to develop and deploy an improved 5th Generation (5G) and/or New Radio (NR) or pre-5G/NR communication system. Therefore, the 5G/NR or pre-5G/NR communication system is also called a “beyond 4G network” or a “post LTE system”. The 5G/NR communication system is considered to be implemented in higher frequency (mmWave) bands, e.g., 28 giga-Hertz (GHz) or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation and the like.

The discussion of 5G systems and technologies associated therewith is for reference as certain embodiments of the present disclosure may be implemented in 5G systems, 6th Generation (6G) systems, or even later releases which may use terahertz (THz) bands. However, the present disclosure is not limited to any particular class of systems, or the frequency bands associated therewith, and embodiments of the present disclosure may be utilized in connection with any frequency band. For example, aspects of the present disclosure may also be applied to deployment of 5G communication systems, 6G communications systems, or communications using THz bands.

### SUMMARY

Methods and apparatuses for power control and beam management to enable coexistence of radar sensing and wireless communication. A method for a UE includes determining a sensing category or characteristics for a sensing application and selecting a spatial filter for radar sensing transmission or reception based on determined sensing category or characteristics. The method further includes identifying a radar sensing transmission power and transmitting or receiving radar sensing signals using the spatial filter and the identified radar sensing transmission power. The method further includes reporting one of communication blockage, radar sensing beam information, or CSI adapted to the radar sensing beam information to a base station or neighboring UEs.

In one embodiment, a user equipment (UE) includes a processor configured to: determine a sensing category or characteristics for a sensing application and select a spatial filter for radar sensing transmission or reception based on determined sensing category or characteristics; and identify a radar sensing transmission power. The user equipment includes a transceiver operatively coupled to the processor, with the transceiver configured to transmit or receive radar sensing signals using the selected spatial filter and the identified radar sensing transmission power, and report one of communication blockage, radar sensing beam information, or channel state information (CSI) adapted to the radar sensing beam information to a base station or neighboring UEs.

In a second embodiment, a method performed by a user equipment (UE) includes one of: determining a sensing category or characteristics for a sensing application and select a spatial filter for radar sensing transmission or reception based on determined sensing category or characteristics; and identifying a radar sensing transmission power. The method also includes transmitting or receiving radar sensing signals using the selected spatial filter and the identified radar sensing transmission power. The method further includes reporting one of communication blockage, radar sensing beam information, or channel state information (CSI) adapted to the radar sensing beam information to a base station or neighboring UEs.

In an embodiment, the spatial filter for radar sensing transmission or reception may be selected based on one or more of: a valid/allowed set of spatial filters indicated by the base station for a sensing reference signal; an adjustment by the base station to a spatial filter reported by the user equipment; or assistance information received by the user equipment from the base station or another user equipment to facilitate the spatial filter selection by the user equipment.

In an embodiment, the assistance information may comprise a set of beam directions for one of downlink (DL), uplink (UL), or sidelink (SL) communication transmission or receptions corresponding to nearby user equipment(s). The processor may be further configured to use the assistance information to select the beam or spatial filter for radar sensing transmission or reception based on: a beam direction among a plurality of beam directions that is less impacted by interference from other user equipment(s); or interference from other user equipment(s) when measuring a reference signal or attempting signal detection.

In an embodiment, the radar sensing transmission power may be based on a linkage with a sensing application category, the radar sensing category associated with one of: radar sensing characteristics; performance requirements for one of target sensing range, maximum sensing range, or minimum sensing range; velocity of the user equipment; or sensing resolution or sensing accuracy.

In an embodiment, the radar sensing transmission power may be based on one of: a sensing power control formula, a target received power for a sensing reference signal, and a corresponding transmission power level achieving the target received power according to the sensing power control formula; a set of target/minimum/maximum/average values corresponding to the sensing parameters selected from parameters including a target/minimum/maximum/average range; a sensing pathloss reference provided to the user equipment by higher layer signaling; a sensing pathloss compensation factor provided to the user equipment by higher layer signaling; one of range bins, velocity bins, angular bins, or radar cross section (RCS) values for accuracy or resolution in sensing performance corresponding to dynamic change of the radar sensing transmission power across different sensing transmission occasions; or power scaling to one of communication by the user equipment or radar sensing by the user equipment.

In an embodiment, an indication may be received of configuration information for resource pools allocated for sharing of resources between communication and radar sensing. The configuration information may comprise one or more of time/frequency resources, maximum transmit power, periodicity, spectrum access mechanism for each resource in a shared resource pool, or maximum percentage of occupation.

In an embodiment, a sensed energy level on shared time/frequency resource pools allocated for radar sensing may be sensed based on configurations for the allocated resource pools configured by a base station. Whether to perform radar sensing signal transmission may be determined and, when performing radar sensing signal transmission is determined, an associated radar sensing signal transmission power level may also be determined based on one of: the sensed energy level on the shared time/frequency resource pools allocated for radar sensing; or information regarding the presence of other signals on the shared time/frequency resource pools allocated for radar sensing.

In an embodiment, an indication may be transmitted to or received by the base station of one or more of: one of an ambient power or signal level on the shared time/frequency resource pools allocated for radar sensing; or a quality of at least one received return radar sensing signal.

In an embodiment, a configuration may be received for radar sensing and transmission power levels for communication or sensing signals transmitted on a resource by one of the base station or another user equipment. The communication or sensing signals may be received on the resource. Based on the configuration for radar sensing and the transmission power levels, passive radar sensing may be performed.

In another embodiment, a base station includes a processor and a transceiver operably coupled to the processor. The transceiver is configured to transmit, to a user equipment (UE), one or more of: an indication of a set of valid/allowed spatial relations configured for radar sensing by the user equipment; an indication of a set of a valid/allowed set of spatial filters for a sensing reference signal; an adjustment by the base station to a spatial filter reported by the user equipment; assistance information to facilitate spatial filter selection by the user equipment; spatial relation(s) for a sensing reference signal; or configuration information for resource pools allocated for sharing of resources between communication and the radar sensing by the user equipment, wherein the configuration information comprises one or more of time/frequency resources, maximum transmit power, periodicity, spectrum access mechanism for each resource in a shared resource pool, or maximum percentage of occupation.

In an embodiment, one of: the valid/allowed set of spatial filters are for a sensing reference signal comprising one of a sounding reference signal (SRS), a sidelink channel state information reference signal (SL CSI-RS), or a radar reference signal (RRS); the transceiver is configured to indicate an adjustment by the base station to a beam or spatial filter reported by the user equipment; or the assistance information comprises a set of beam directions for one of downlink (DL), uplink (UL), or sidelink (SL) communication transmission or receptions corresponding to nearby user equipment(s).

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an exemplary networked system utilizing communication and sensing according to various embodiments of this disclosure;

FIG. 2 illustrates an exemplary base station (BS) utilizing communication and sensing according to various embodiments of this disclosure;

FIG. 3 illustrates an exemplary electronic device for communicating in the networked computing system utilizing communication and sensing according to various embodiments of this disclosure;

FIG. 4 shows an example flowchart for UE-based selection of Tx beam for radar sensing transmission based on the sensing application category, gNB configuration of valid beams, and other neighbor UEs' assistance information, according to embodiments of the present disclosure;

FIG. 5 shows an example BS-side flowchart for UE transmit power control on shared resource pools, according to embodiments of the present disclosure;

FIG. 6 shows an example UE-side flowchart for UE transmit power control on shared resource pools, according to embodiments of the present disclosure;

FIG. 7 shows an example BS-side flowchart for UE sensing beam selection report, according to embodiments of the present disclosure;

FIG. 8 shows an example UE-side flowchart for UE sensing beam selection report, according to embodiments of the present disclosure;

FIG. 9 shows an example BS-side flowchart for time/frequency resource configuration for passive sensing, according to embodiments of the present disclosure;

FIG. 10 shows an example UE-side flowchart for time/frequency resource configuration for passive sensing, according to embodiments of the present disclosure; and

FIGS. 11A, 11B, 11C, and 11D diagrammatically illustrate, respectively, separate antenna panels and a common antenna panel for wireless communication and radar in the UE 116 of FIG. 3.

### DETAILED DESCRIPTION

The figures included herein, and the various embodiments used to describe the principles of the present disclosure are by way of illustration only and should not be construed in any way to limit the scope of the disclosure. Further, those skilled in the art will understand that the principles of the present disclosure may be implemented in any suitably arranged wireless communication system.

### REFERENCES

[1] 3GPP TS 38.211 Rel-16 v16.4.0, “NR; Physical channels and modulation,” Dec. 2020.
[2] 3GPP TS 38.212 Rel-16 v16.4.0, “NR; Multiplexing and channel coding,” Dec. 2020.
[3] 3GPP TS 38.213 Rel-16 v16.4.0, “NR; Physical layer procedures for control,” Dec. 2020.
[4] 3GPP TS 38.214 Rel-16 v16.4.0, “NR; Physical layer procedures for data,” Dec. 2020.
[5] 3GPP TS 38.321 Rel-16 v16.3.0, “NR; Medium Access Control (MAC) protocol specification,” Dec. 2020.
[6] 3GPP TS 38.331 Rel-16 v16.3.0, “NR; Radio Resource Control (RRC) protocol specification,” Dec. 2020.
[7] 3GPP TS 38.300 Rel-16 v16.4.0, “NR; NR and NG-RAN Overall Description; Stage 2,” Dec. 2020.

The above-identified references are incorporated herein by reference.

### Abbreviations:

3GPP Third generation partnership project
ACK Acknowledgement
AP Antenna port
BCCH Broadcast control channel
BCH Broadcast channel
BD Blind decoding
BFR Beam failure recovery
BI Back-off indicator
BW Bandwidth
BLER Block error ratio
BL/CE Bandwidth limited, coverage enhanced
BWP Bandwidth Part
CA Carrier aggregation
CB Contention based
CBG Code block group
CBRA Contention based random access
CBS PUR Contention based shared PUR
CCE Control Channel Element
CD-SSB Cell-defining SSB
CE Coverage enhancement
CFRA Contention free random access
CFS PUR Contention free shared PUR
CG Configured grant
CGI Cell global identifier
CI Cancellation indication
CORESET Control Resource Set
CP Cyclic prefix
C-RNTI Cell RNTI
CRB Common resource block
CR-ID Contention resolution identity
CRC Cyclic Redundancy Check
CSI Channel State Information
CSI-RS Channel State Information Reference Signal
CS-G-RNRI Configured scheduling group RNTI
CS-RNTI Configured scheduling RNTI
CSS Common search space
DAI Downlink assignment index
DCI Downlink Control Information
DFI Downlink Feedback Information
DL Downlink
DMRS Demodulation Reference Signal
DTE Downlink transmission entity
EIRP Effective isotropic radiated power
eMTC enhanced machine type communication
EPRE Energy per resource element
FDD Frequency Division Duplexing
FDM Frequency division multiplexing
FDRA Frequency domain resource allocation
FR1 Frequency range 1
FR2 Frequency range 2
gNB gNodeB
GPS Global positioning system
HARQ Hybrid automatic repeat request
HARQ-ACK Hybrid automatic repeat request acknowledgement
HARQ-NACK Hybrid automatic repeat request negative acknowledgement
HPN HARQ process number
ID Identity
IE Information element
IIoT Industrial internet of things
IoT Internet of Things
KPI Key performance indicator
LBT Listen before talk
LNA Low-noise amplifier
LRR Link recovery request
LSB Least significant bit
LTE Long Term Evolution
MAC Medium access control
MAC-CE MAC control element
MCG Master cell group
MCS Modulation and coding scheme
MIB Master Information Block
MIMO Multiple input multiple output
MPE maximum permissible exposure
MTC Machine type communication
mMTC massive machine type communication
MSB Most significant bit
NACK Negative acknowledgment
NDI New data indicator
NPN Non-public network
NR New Radio
NR-L NR Light/NR Lite
NR-U NR unlicensed
NTN Non-terrestrial network
OSI Other system information
PA Power amplifier
PI Preemption indication
PBCH Physical broadcast channel
PCell Primary cell
PRACH Physical Random Access Channel
PDCCH Physical Downlink Control Channel
PDSCH Physical Downlink Shared Channel
PUCCH Physical Uplink Control Channel
PUSCH Physical Uplink Shared Channel
PMI Precoder matrix indicator
P-MPR Power Management Maximum Power Reduction
PO PUSCH occasion
PSCell Primary secondary cell
PSS Primary synchronization signal
P-RNTI Paging RNTI
PRG Precoding resource block group
PRS Positioning reference signal
PTRS Phase tracking reference signal
PUR Pre-configured uplink resource
QCL Quasi co-located/Quasi co-location
RA Random access
RACH Random access channel
RAPID Random access preamble identity
RAR Random access response
RA-RNTI Random access RNTI
RAN Radio Access Network
RAT Radio access technology
RB Resource Block
RBG Resource Block group
RF Radio Frequency
RLF Radio link failure
RLM Radio link monitoring
RMSI Remaining minimum system information
RNTI Radio Network Temporary Identifier
RO RACH occasion
RRC Radio Resource Control
RS Reference Signal
RSRP Reference signal received power
RV Redundancy version
Rx Receive/Receiving
SAR Specific absorption rate
SCG Secondary cell group
SFI Slot format indication
SFN System frame number
SI System Information
SI-RNTI System Information RNTI
SIB System Information Block
SINR Signal to Interference and Noise Ratio
SCS Sub-carrier spacing
SMPTx Simultaneous multi-panel transmission
SMPTRx Simultaneous multi-panel transmission and reception
SpCell Special cell
SPS Semi-persistent scheduling
SR Scheduling Request
SRI SRS resource indicator
SRS Sounding reference signal
SS Synchronization signal
SSB SS/PBCH block
SSS Secondary synchronization signal
STxMP Simultaneous transmission by multiple panels
STRxMP Simultaneous transmission and reception by multiple panels
TA Timing advance
TB Transport Block
TBS Transport Block size
TCI Transmission Configuration Indication
TC-RNTI Temporary cell RNTI
TDD Time Division Duplexing
TDM Time division multiplexing
TDRA Time domain resource allocation
TPC Transmit Power Control
TRP Total radiated power
Tx Transmit/Transmitting
UCI Uplink Control Information
UE User Equipment
UL Uplink
UL-SCH Uplink shared channel
URLLC Ultra reliable and low latency communication
UTE Uplink transmission entity
V2X Vehicle to anything
VOIP Voice over Internet Protocol (IP)
XR extended reality

The present disclosure relates to beyond 5G or 6G communication systemS to be provided for supporting one or more of: higher data rates, lower latency, higher reliability, improved coverage, and massive connectivity, and so on. Various embodiments apply to UEs operating with other RATs and/or standards, such as different releases/generations of 3GPP standards (including beyond 5G, 6G, and so on), IEEE standards (such as 802.11/15/16), and so forth.

This disclosure pertains joint communication and radar sensing, wherein a UE is able to perform downlink/uplink/sidelink communication and also perform radar sensing by “sensing”/detecting environmental objects and their physical characteristics such as location/range, velocity/speed, elevation, angle, and so on. Radar sensing is achieved by sending a suitable sounding waveform and receiving and analyzing reflections or echoes of the sounding waveform. Such radar sensing operation can be used for applications and use-case such as proximity sensing, liveness detection, gesture control, face recognition, room/environment sensing, motion/presence detection, depth sensing, and so on, for various UE form factors. For some larger UE form factors, such as (driver-less) vehicles, trains, drones and so on, radar sensing can be additionally used for speed/cruise control, lane/elevation change, rear/blind spot view, parking assistance, and so on. Such radar sensing operation can be performed in various frequency bands, including millimeter wave (mmWave)/FR2 bands. In addition, with THz spectrum, ultra-high resolution sensing, such as sub-cm level resolution, and sensitive Doppler detection, such as micro-Doppler detection, can be achieved with very large bandwidth allocation, for example, on the order of several GHz or more.

Current implementations can support individual operation of communication and sensing, wherein the UE is equipped with separate modules, in terms of baseband processing units and/or RF chain and antenna arrays, for communication procedures and radar procedures. The separate communication and sensing architecture requires repetitive implementation that increased UE complexity. In addition, since the two modules are designed separately, there is little/no coordination between them, so time/frequency/sequence/spatial resources are not efficiently used by the two modules, which in some cases can even lead to (self-) interference between the two modules of a same UE. In addition, the radar sensing operation of the UE can be based on pure implementation based methods and without any unified standards support, which can cause (significant) inter-UE issues, or may not be fully compatible with cellular systems. Furthermore, separate design of the two modules makes it difficult to use measurement or information acquired by one module to assist the other module. For example, the communication module may be unaware of a potential beam blockage due to a nearby object, although the sensing module may have already detected the object.

There is a need to develop a unified standard for support of joint communication and sensing to reduce the UE implementation complexity and enable coexistence of the two modules. There is another need to ensure time/frequency/sequence/spatial resources are efficiently used across communication and sensing modules of a same UE, as well as among different UEs performing these two operations, to reduce/avoid (self-) interference. There is a further need to design the two operations in such a way to provide assistance to each other by exchanging measurement results and acquired information, so that both procedures can operate more robustly and effectively.

The present disclosure provides designs for the support of joint communication and radar sensing. The disclosure aims for optimal signal design and processing block architecture that can be reused for both communication and sensing. In addition, sensing operation can be integrated into the frame structure and bandwidth configuration. Furthermore, a unified design can achieve coordination between BS-UE for uninterrupted communication, and UE-UE to minimize the impact of interference due to sensing.

Several aspects and elements of an NR communication module can be re-used for radar operation, such as waveform transmission, resource/sequence allocation, and reception procedure. Therefore, it is possible to coherently re-use existing NR communication design, possibly with suitable modification, to perform radar operations tasks. It is expected that the overall UE complexity can be reasonably reduced based on such unified design, coexistence, and cooperation. Various techniques are provided for coordinated configuration of non-overlapping time/frequency/sequence/spatial resources to reduce/eliminate any intra-UE interference, and accommodate high quality (such as high-SINR) reception of channels and signals for both DL/UL/SL communications and radar sensing, which increases the performance for both operations. In addition, various coordination mechanisms between UE and gNB, as well as between (neighbor) UEs, are considered that can minimize inter-UE interference. Various design aspects are proposed for an NR-compatible radar sensing waveform with high radar detection performance. In particular, as an example, SRS or SL CSI-RS can be good candidates as a radar reference signal (RRS), wherein modifications to those reference signals are disclosed for improved radar performance, such as enhanced time patterns, improved frequency allocation, and flexible beam/spatial filter configuration. Moreover, several methods for radar sensing transmission power control are presented in line with NR power control framework and/or aligned with radar power equation. Finally, multiple approaches are described for exchange of assistance information between communication and radar sensing for more efficient communication operation, such as for beam management or CSI reporting, or for efficient radar sensing using legacy communication signals.

One motivation of this disclosure is to support radar sensing operation in beyond 5G or in 6G, especially in higher frequency bands such as the ones above 6 GHZ, mm Wave, and even Tera Hz (THz) bands. In addition, the embodiments can apply to various use cases and settings, such as frequency bands below 6 GHZ, eMBB, URLLC and IIoT and XR, mMTC and IoT, sidelink/V2X, operation in unlicensed/shared spectrum (NR-U), non-terrestrial networks (NTN), aerial systems such as drones, operation with reduced capability (RedCap) UEs, private or non-public networks (NPN), and so on.

Embodiments of the disclosure for supporting joint communication and radar sensing procedures are summarized in the following and are fully elaborated further below.

### E-1) Beam Management for Radar Sensing Reference Signal:

In one embodiment, a beam or spatial filter for radar sensing transmission or reception can be per UE selection based on the sensing application, with possible gNB configuration of a (n) valid/allowed set of beams/spatial filters, or gNB indication of an adjustment to the UE-selected beam, or assistance information from gNB or other UEs to help the UE select the beam.

### E-2) Power Control for Radar Sensing RS:

In one embodiment, a transmission power for radar sensing RS, such as sensing SRS or SL CSI-RS for sensing, can be semi-statically configured or can be determined based on a semi-statically configured received power for sensing along with full or partial pathloss compensation.

### E-3) Signaling and Information Exchange Between Radar and Communication:

In one embodiment, there can be a signaling, information exchange, or interaction between radar sensing and DL/UL/SL communication. According to this embodiment, radar sensing not only provides measurements and information for UE's higher layer applications, it also can provide information or assistance to communication procedures. Therefore, the UE can use radar sensing measurement reports or information to improve its communication performance. For example, the UE's radar sensing module can provide such information to the UE's communication module. Alternatively, the UE can use DL/UL/SL communication to assist UE's radar sensing.

A description of example embodiments is provided on the following pages.

The text and figures are provided solely as examples to aid the reader in understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

Aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive. The invention is illustrated by way of example, and not by way of limitation, in the figures of the accompanying drawings.

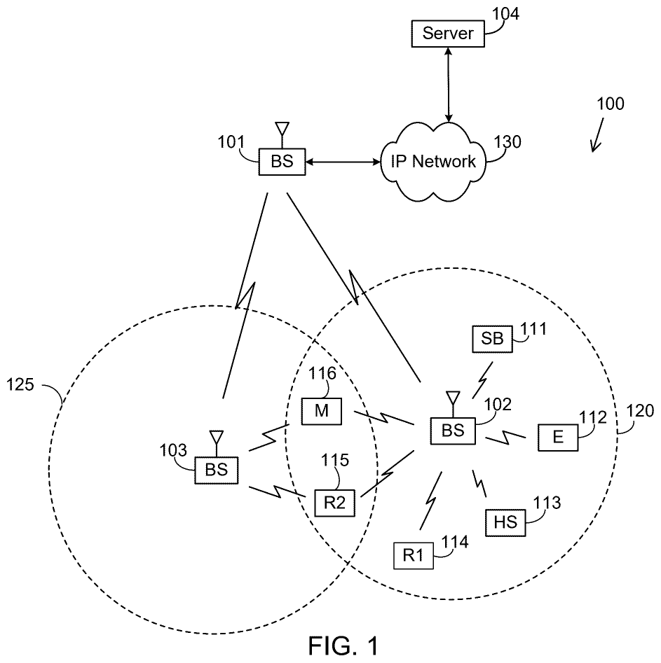

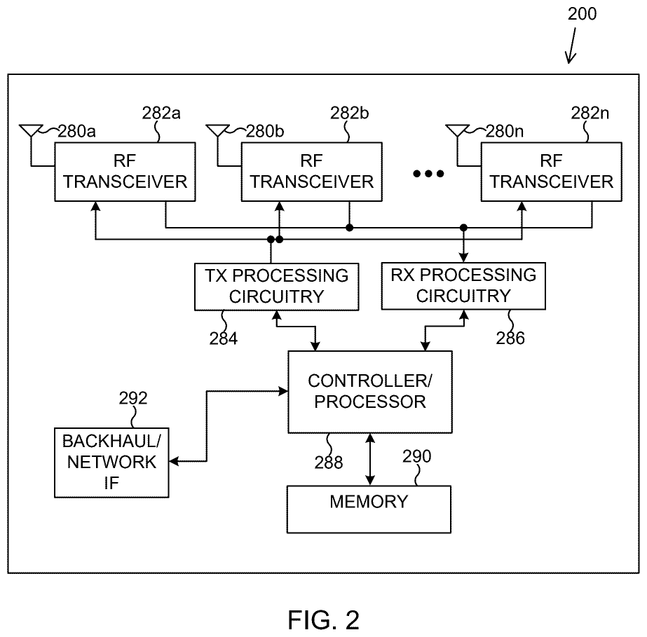

Throughout this disclosure, all figures such as FIG. 1, FIG. 2, and so on, illustrate examples according to embodiments of the present disclosure. For each figure, the corresponding embodiment shown in the figure is for illustration only. One or more of the components illustrated in each figure can be implemented in specialized circuitry configured to perform the noted functions or one or more of the components can be implemented by one or more processors executing instructions to perform the noted functions. Other embodiments could be used without departing from the scope of the present disclosure. In addition, the descriptions of the figures are not meant to imply physical or architectural limitations to the manner in which different embodiments may be implemented. Different embodiments of the present disclosure may be implemented in any suitably-arranged communications system.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Throughput the present disclosure, the term “gNB” is used to refer to a cellular base station, such as a 5G/6G base station (possibly referred to as ‘gNB’ or any other terminology) or, in general, a network node or access point of a wireless system.

Throughput the present disclosure, the terms “SSB” and “SS/PBCH block” are used interchangeably.

Throughout the present disclosure, the term “configuration” and variations thereof (such as “configured” and so on) are used to refer to one or more of: a system information signaling such as by a MIB or a SIB, a common higher layer/RRC signaling, and a dedicated higher layer/RRC signaling.

Throughput the present disclosure, the term “higher layer configuration” are used to refer to one or more of system information (such as SIB1), or common/cell-specific RRC configuration, or dedicated/UE-specific RRC configuration, or modifications or extensions or combinations thereof.

Throughout the present disclosure, the term signal quality is used to refer to e.g., RSRP or RSRQ or RSSI or SINR, with or without filtering such as L1 or L3 filtering, of a channel or a signal such as a reference signal (RS) including SSB, CSI-RS, or SRS.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same PRG.

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a PBCH, the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE may assume that SS/PBCH blocks transmitted with the same block index on the same center frequency location are quasi co-located with respect to Doppler spread, Doppler shift, average gain, average delay, delay spread, and, when applicable, spatial Rx parameters. The UE shall not assume quasi co-location for any other SS/PBCH block transmissions.

In absence of CSI-RS configuration, and unless otherwise configured, the UE may assume PDSCH DM-RS and SS/PBCH block to be quasi co-located with respect to Doppler shift, Doppler spread, average delay, delay spread, and, when applicable, spatial Rx parameters. The UE may assume that the PDSCH DM-RS within the same CDM group are quasi co-located with respect to Doppler shift, Doppler spread, average delay, delay spread, and spatial Rx. The UE may also assume that DMRS ports associated with a PDSCH are QCL with QCL Type A, Type D (when applicable) and average gain. The UE may further assume that no DM-RS collides with the SS/PBCH block.

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi co-location (QCL) relationship between one or two downlink reference signals and the DMRS ports of the PDSCH, the DMRS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives a MAC-CE activation command to map up to [N] (e.g., N=8) TCI states to the codepoints of the DCI field ‘Transmission Configuration Indication’. When the HARQ-ACK corresponding to the PDSCH carrying the activation command is transmitted in slot n, the indicated mapping between TCI states and codepoints of the DCI field ‘Transmission Configuration Indication’ should be applied after a MAC-CE application time, e.g., starting from the first slot that is after slot e.g.,

$$n + 3 {N}_{slot}^{subframe , μ} .$$

Various link adaptation types are supported including:
Adaptive transmission bandwidth;
Adaptive transmission duration;
Transmission power control;
Adaptive modulation and channel coding rate.

For channel state estimation purposes, the UE may be configured to transmit SRS that the gNB may use to estimate the uplink channel state and use the estimate in link adaptation.

The periodic, semi-persistent and aperiodic transmission of SRS is defined for gNB UL RTOA, UL SRS-RSRP, UL-AoA measurements to facilitate support of UL TDOA and UL AoA positioning methods as described in TS 38.305.

The periodic, semi-persistent and aperiodic transmission of SRS for positioning is defined for gNB UL RTOA, UL SRS-RSRP, UL-AoA, gNB Rx-Tx time difference measurements to facilitate support of UL TDOA, UL AoA and multi-RTT positioning methods as described in TS 38.305.

The DL Positioning Reference Signals (DL PRS) are defined to facilitate support of different positioning methods such as DL-TDOA, DL-AOD, multi-RTT through the following set of UE measurements DL RSTD, DL PRS-RSRP, and UE Rx-Tx time difference respectively as described in TS 38.305.

Besides DL PRS signals, UE can use SSB and CSI-RS for RRM (RSRP and RSRQ) measurements for E-CID type of positioning.

The atmospheric ducting phenomenon, caused by lower densities at higher altitudes in the Earth's atmosphere, causes a reduced refractive index, causing the signals to bend back towards the Earth. A signal trapped in the atmospheric duct can reach distances far greater than normal. In TDD networks with the same UL/DL slot configuration, and in the absence of atmospheric ducting, a guard period is used to avoid the interference between UL and DL transmissions in different cells. However, when the atmospheric ducting phenomenon happens, radio signals can travel a relatively long distance, and the propagation delay exceeds the guard period. Consequently, the DL signals of an aggressor cell can interfere with the UL signals of a victim cell that is far away from the aggressor. Such interference is termed as remote interference. The further the aggressor is to the victim, the more UL symbols of the victim will be impacted.

A remote interference scenario may involve a number of victim and aggressor cells, where the gNBs execute Remote Interference Management (RIM) coordination on behalf of their respective cells. Aggressor and victim gNBs can be grouped into semi-static sets, where each cell is assigned a set ID, and is configured with a RIM Reference Signal (RIM-RS) and the radio resources associated with the set ID. Each aggressor gNB can be configured with multiple set IDs and each victim gNB can be configured with multiple set IDs, whereas each cell can have at most one victim set ID and one aggressor set ID. Consequently, each gNB can be an aggressor and a victim at the same time.

To mitigate remote interference, the network enables RIM frameworks for coordination between victim and aggressor gNBs. The coordination communication in RIM frameworks can be wireless- or backhaul-based. The backhaul-based RIM framework uses a combination of wireless and backhaul communication, while in the wireless framework, the communication is purely wireless.

In both frameworks, all gNBs in a victim set simultaneously transmit an identical RIM reference signal carrying the victim set ID over the air.

In the wireless framework, upon reception of the RIM reference signal from the victim set, aggressor gNBs undertake RIM measures, and send back a RIM reference signal carrying the aggressor set ID. The RIM reference signal sent by the aggressor is able to provide information whether the atmospheric ducting phenomenon exists. The victim gNBs realize the atmospheric ducting phenomenon have ceased upon not receiving any reference signal sent from aggressors.

In the RIM backhaul framework, upon reception of the RIM reference signal from the victim set, aggressor gNBs undertake RIM measures, and establish backhaul coordination towards the victim gNB set. The backhaul messages are sent from individual aggressor gNBs to individual victim gNB, where the signaling is transparent to the core network. The RIM backhaul messages from aggressor to victim gNBs carry the indication about the detection or disappearance of RIM reference signal. Based on the indication from the backhaul message, the victim gNBs realize whether the atmospheric ducting and the consequent remote interference have ceased.

In both frameworks, upon realizing that the atmospheric ducting has disappeared, the victim gNBs stop transmitting the RIM reference signal.

When different TDD DL/UL patterns are used between neighboring cells, UL transmission in one cell may interfere with DL reception in another cell: this is referred to as Cross Link Interference (CLI).

To mitigate CLI, gNBs can exchange and coordinate their intended TDD DL-UL configurations over Xn and F1 interfaces; and the victim UEs can be configured to perform CLI measurements. There are two types of CLI measurements:
SRS-RSRP measurement in which the UE measures SRS-RSRP over SRS resources of aggressor UE(s);
CLI-RSSI measurement in which the UE measures the total received power observed over RSSI resources.

Layer 3 filtering applies to CLI measurement results and both event triggered and periodic reporting are supported.

Sidelink supports UE-to-UE direct communication using the sidelink resource allocation modes, physical-layer signals/channels, and physical layer procedures below.

Two sidelink resource allocation modes are supported: mode 1 and mode 2. In mode 1, the sidelink resource allocation is provided by the network. In mode 2, UE decides the SL transmission resources in the resource pool(s).

Physical Sidelink Control Channel (PSCCH) indicates resource and other transmission parameters used by a UE for PSSCH. PSCCH transmission is associated with a DM-RS.

Physical Sidelink Shared Channel (PSSCH) transmits the TBs of data themselves, and control information for HARQ procedures and CSI feedback triggers, etc. At least 6 OFDM symbols within a slot are used for PSSCH transmission. PSSCH transmission is associated with a DM-RS and may be associated with a PT-RS.

Physical Sidelink Feedback Channel (PSFCH) carries HARQ feedback over the sidelink from a UE which is an intended recipient of a PSSCH transmission to the UE which performed the transmission. PSFCH sequence is transmitted in one PRB repeated over two OFDM symbols near the end of the sidelink resource in a slot.

The sidelink synchronization signal consists of sidelink primary and sidelink secondary synchronization signals (S-PSS, S-SSS), each occupying 2 symbols and 127 subcarriers. Physical Sidelink Broadcast Channel (PSBCH) occupies 9 and 5 symbols for normal and extended cyclic prefix cases respectively, including the associated DM-RS.

Sidelink HARQ feedback uses PSFCH and can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs.

In sidelink resource allocation mode 1, a UE which received PSFCH can report sidelink HARQ feedback to gNB via PUCCH or PUSCH.

For in-coverage operation, the power spectral density of the sidelink transmissions can be adjusted based on the pathloss from the gNB.

For unicast, the power spectral density of some sidelink transmissions can be adjusted based on the pathloss between the two communicating UEs.

For unicast, channel state information reference signal (CSI-RS) is supported for CSI measurement and reporting in sidelink. A CSI report is carried in a sidelink MAC CE.

For measurement on the sidelink, the following UE measurement quantities are supported:
PSBCH reference signal received power (PSBCH RSRP);
PSSCH reference signal received power (PSSCH-RSRP);
PSCCH reference signal received power (PSCCH-RSRP);
Sidelink received signal strength indicator (SL RSSI);
Sidelink channel occupancy ratio (SL CR);
Sidelink channel busy ratio (SL CBR).

A sounding reference signal (SRS) is generated based on Zadoff-Chu (ZC) sequence, which has a constant amplitude in time and frequency domain, and also has zero cyclic autocorrelation for any non-zero cyclic shift.

The UE may be configured with one or more Sounding Reference Signal (SRS) resource sets as configured by the higher layer parameter SRS-ResourceSet or SRS-PosResourceSet. For each SRS resource set configured by SRS-ResourceSet, a UE may be configured with K≥1 SRS resources (higher layer parameter SRS-Resource), where the maximum value of K is indicated by UE capability. When SRS is configured with the higher layer parameter SRS-PosResourceSet, a UE may be configured with SRS resources (higher layer parameter SRS-PosResource), where the maximum value of K is 16. The SRS resource set applicability is configured by the higher layer parameter usage in SRS-ResourceSet. When the higher layer parameter usage is set to ‘beamManagement’, only one SRS resource in each of multiple SRS sets may be transmitted at a given time instant, but the SRS resources in different SRS resource sets with the same time domain behavior in the same BWP may be transmitted simultaneously.

For aperiodic SRS at least one state of the DCI field is used to select at least one out of the configured SRS resource set(s).

The following SRS parameters are semi-statically configurable by higher layer parameter SRS-Resource or SRS-PosResource.
srs-ResourceId or SRS-PosResourceId determines SRS resource configuration identity.
Number of SRS ports as defined by the higher layer parameter nrofSRS-Ports. If not configured, nrofSRS-Ports is 1.
Time domain behavior of SRS resource configuration as indicated by the higher layer parameter resourceType, which may be periodic, semi-persistent, aperiodic SRS transmission.
Slot level periodicity and slot level offset as defined by the higher layer parameters periodicityAndOffset-p or periodicityAndOffset-sp for an SRS resource of type periodic or semi-persistent, which is configured by SRS-Resource, and periodicityAndOffset-p or periodicityAndOffset-sp for an SRS resource of type periodic or semi-persistent, which is configured by SRS-PosResource. The UE is not expected to be configured with SRS resources in the same SRS resource set SRS-ResourceSet or SRS-PosResourceSet with different slot level periodicities. For an SRS-ResourceSet configured with higher layer parameter resourceType set to ‘aperiodic’, a slot level offset is defined by the higher layer parameter slotOffset. For an SRS-PosResourceSet configured with higher layer parameter resourceType-r16 set to ‘aperiodic-r16’, the slot level offset is defined by the higher layer parameter slotOffset-r16 for each SRS resource.
Number of OFDM symbols in the SRS resource, starting OFDM symbol of the SRS resource within a slot including repetition factor R as defined by the higher layer parameter resourceMapping or resourceMapping-r16. If R is not configured, then R is equal to the number of OFDM symbols in the SRS resource.
SRS bandwidth B_{SRS} and C_{SRS}, as defined by the higher layer parameter freqHopping or freqHopping-r16. If not configured, then B_{SRS}=0.
Frequency hopping bandwidth, bₕₒₚ, as defined by the higher layer parameter freqHopping or freqHopping-r16. If not configured, then bₕₒₚ=0.
Defining frequency domain position and configurable shift, as defined by the higher layer parameters freqDomainPosition and freqDomainShift or freqDomainShift-r16, respectively. If freqDomainPosition is not configured, freqDomainPosition is zero.
Cyclic shift, as defined by the higher layer parameter cyclicShift-n2 or cyclicShift-n4 for transmission comb value 2 or 4 for an SRS configured by SRS-Resource respectively, and defined by the higher layer parameter cyclicShift-n2-r16, cyclicShift-n4-r16, or cyclicShift-n8-r16 for transmission comb value 2, 4 or 8 for an SRS configured by SRS-PosResource, respectively.
Transmission comb value as defined by the higher layer parameter transmissionComb.
Transmission comb offset as defined by the higher layer parameter combOffset-n2 or combOffset-n4 for transmission comb value 2 or 4 for an SRS configured by SRS-Resource respectively, and defined by the higher layer parameter combOffset-n2-r16, combOffset-n4-r16, or combOffset-n8-r16 for transmission comb value 2, 4, or 8 for an SRS configured by SRS-PosResource, respectively.
SRS sequence ID as defined by the higher layer parameter sequenceId or sequenceId-r16.
The configuration of the spatial relation between a reference RS and the target SRS, where the higher layer parameter spatialRelationInfo or spatialRelationInfoPos, if configured, contains the ID of the reference RS. The reference RS may be an SS/PBCH block, CSI-RS configured on serving cell indicated by higher layer parameter servingCellId if present, same serving cell as the target SRS otherwise, or an SRS configured on uplink BWP indicated by the higher layer parameter uplinkBWP or uplinkBWP-r16, and serving cell indicated by the higher layer parameter servingCellId if present, same serving cell as the target SRS otherwise. When the target SRS is configured by the higher layer parameter SRS-PosResourceSet, the reference RS may also be a DL PRS configured on a serving cell or a non-serving cell indicated by the higher layer parameter dl-PRS, or an SS/PBCH block of a non-serving cell indicated by the higher layer parameter ssb-Ncell.

The UE may be configured by the higher layer parameter resourceMapping in SRS-Resource with an SRS resource occupying N_{S}∈{1,2,4} adjacent OFDM symbols within the last 6 symbols of the slot, or at any symbol location within the slot if resourceMapping-r16 is provided subject to UE capability, where all antenna ports of the SRS resources are mapped to each symbol of the resource. When the SRS is configured with the higher layer parameter SRS-PosResourceSet the higher layer parameter resourceMapping in SRS-PosResource with an SRS resource occupying N_{S}∈{1,2,4,8,12} adjacent symbols anywhere within the slot.

If a PUSCH with a priority index 0 and SRS configured by SRS-Resource are transmitted in the same slot on a serving cell, the UE may only be configured to transmit SRS after the transmission of the PUSCH and the corresponding DM-RS.

If a PUSCH transmission with a priority index 1 or a PUCCH transmission with a priority index 1 would overlap in time with an SRS transmission on a serving cell, the UE does not transmit the SRS in the overlapping symbol(s).

The UE is not expected to be configured with different time domain behavior for SRS resources in the same SRS resource set. The UE is also not expected to be configured with different time domain behavior between SRS resource and associated SRS resources set.

For operation in the same carrier, the UE is not expected to be configured on overlapping symbols with a SRS resource configured by the higher layer parameter SRS-PosResource and a SRS resource configured by the higher layer parameter SRS-Resource with resourceType of both SRS resources as ‘periodic’.

For operation in the same carrier, the UE is not expected to be triggered to transmit SRS on overlapping symbols with a SRS resource configured by the higher layer parameter SRS-PosResource and a SRS resource configured by the higher layer parameter SRS-Resource with resourceType of both SRS resources as ‘semi-persistent’ or ‘aperiodic’.

For operations in the same carrier, the UE is not expected to be configured on overlapping symbols with more than one SRS resources configured by the higher layer parameter SRS-PosResource with resourceType of the SRS resources as ‘periodic’.

For operations in the same carrier, the UE is not expected to be triggered to transmit SRS on overlapping symbols with more than one SRS resources configured by the higher layer parameter SRS-PosResource with resourceType of the SRS resources as ‘semi-persistent’ or ‘aperiodic’.

For intra-band and inter-band CA operations, a UE can simultaneously transmit more than one SRS resource configured by SRS-PosResource on different CCs, subject to UE's capability

For intra-band and inter-band CA operations, a UE can simultaneously transmit more than one SRS resource configured by SRS-PosResource and SRS-Resource on different CCs, subject to UE's capability.

The SRS request field in DCI format 0_1, 1_1, 0_2 (if SRS request field is present), 1_2 (if SRS request field is present) indicates a triggered SRS resource set. The 2-bit SRS request field in DCI format 2_3 indicates a triggered SRS resource set if the UE is configured with higher layer parameter srs-TPC-PDCCH-Group set to ‘typeB’, or indicates the SRS transmission on a set of serving cells configured by higher layers if the UE is configured with higher layer parameter srs-TPC-PDCCH-Group set to ‘typeA’.

When the higher layer parameter enableDefaultBeamPL-ForSRS is set ‘enabled’, and if the higher layer parameter spatialRelationInfo for the SRS resource, except for the SRS resource with the higher layer parameter usage in SRS-ResourceSet set to ‘beamManagement’ or for the SRS resource with the higher layer parameter usage in SRS-ResourceSet set to ‘nonCodebook’ with configuration of associatedCSI-RS or for the SRS resource configured by the higher layer parameter SRS-PosResourceSet, is not configured in FR2 and if the UE is not configured with higher layer parameter(s) pathlossReferenceRS, and if the UE is not configured with different values of coresetPoolIndex in ControlResourceSets, and is not provided at least one TCI codepoint mapped with two TCI states, the UE shall transmit the target SRS resource in an active UL BWP of a CC,
according to the spatial relation, if applicable, with a reference to the RS configured with qcl-Type set to ‘typeD’ corresponding to the QCL assumption of the CORESET with the lowest controlResourceSetId in the active DL BWP in the CC.
according to the spatial relation, if applicable, with a reference to the RS configured with qcl-Type set to ‘typeD’ in the activated TCI state with the lowest ID applicable to PDSCH in the active DL BWP of the CC if the UE is not configured with any CORESET in the active DL BWP of the CC.

When the SRS is configured by the higher layer parameter SRS-PosResource and if the higher layer parameter spatialRelationInfoPos is configured, it contains the ID of the configuration fields of a reference RS. The reference RS can be an SRS configured by the higher layer parameter SRS-Resource or SRS-PosResource, CSI-RS, SS/PBCH block, or a DL PRS configured on a serving cell or a SS/PBCH block or a DL PRS configured on a non-serving cell.

The UE is not expected to transmit multiple SRS resources with different spatial relations in the same OFDM symbol.

If the UE is not configured with the higher layer parameter spatialRelationInfoPos the UE may use a fixed spatial domain transmission filter for transmissions of the SRS configured by the higher layer parameter SRS-PosResource across multiple SRS resources or it may use a different spatial domain transmission filter across multiple SRS resources.

The UE is only expected to transmit an SRS configured the by the higher layer parameter SRS-PosResource within the active UL BWP of the UE.

When the configuration of SRS is done by the higher layer parameter SRS-PosResource, the UE can only be provided with a single RS source in spatialRelationInfoPos per SRS resource for positioning.

For operation on the same carrier, if an SRS configured by the higher parameter SRS-PosResource collides with a scheduled PUSCH, the SRS is dropped in the symbols where the collision occurs.

The UE does not expect to be configured with SRS-PosResource on a BWP not configured with PUSCH/PUCCH transmission.

An SRS resource set can be configured with a parameter “usage” that can take a value of ‘code-book-based’, ‘non-code-book-based’, ‘beam management’, or ‘antenna switching’.

If a UE transmits SRS based on a configuration by SRS-ResourceSet on active UL BWP b of carrier f of serving cell c using SRS power control adjustment state with index l, the UE determines the SRS transmission power P_{SRS,b,f,c}(i, qₛ, l) in SRS transmission occasion i as

$${P}_{SRS , b , f , c} ( i , {q}_{s} , l ) = min \{ \begin{matrix}{P}_{CMAX , f , c} ( i ) , \\ {P}_{O \_ SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i , l )\end{matrix} \} [ dBm ]$$

where
P_{CMAX,f,c}(i) is the UE configured maximum output power defined in [TS 38.101-1], [TS38.101-2] and [TS 38.101-3] for carrier f of serving cell c in SRS transmission occasion i
P_{O_SRS,b,f,c}(qₛ) is provided by p0 for active UL BWP b of carrier f of serving cell c and SRS resource set qₛ provided by SRS-ResourceSet and SRS-ResourceSetId
M_{SRS,b,f,c}(i) is a SRS bandwidth expressed in number of resource blocks for SRS transmission occasion i on active UL BWP b of carrier f of serving cell c and μ is a SCS configuration defined in [TS 38.211]
@_{SRS,b,f,c}(qₛ) is provided by alpha for active UL BWP b of carrier f of serving cell c and SRS resource set qₛ
PL_{b,f,c}(q_{d}) is a downlink pathloss estimate in dB calculated by the UE using RS resource index q_{d} for the active DL BWP of serving cell c and SRS resource set qₛ [TS 38.214]. The RS resource index q_{d} is provided by pathlossReferenceRS associated with the SRS resource set qₛ and is either an ssb-Index providing a SS/PBCH block index or a csi-RS-Index providing a CSI-RS resource index. If the UE is provided enablePL-RS-UpdateForPUSCH-SRS, a MAC CE [TS 38.321] can provide by SRS-PathlossReferenceRS-Id a corresponding RS resource index q_{d} for aperiodic or semi-persistent SRS resource set qₛ
If the UE is not provided pathlossReferenceRS or SRS-PathlossReferenceRS-Id, or before the UE is provided dedicated higher layer parameters, the UE calculates PL_{b,f,c}(q_{d}) using a RS resource obtained from an SS/PBCH block with same SS/PBCH block index as the one the UE uses to obtain MIB
If the UE is provided pathlossReferenceLinking, the RS resource is on a serving cell indicated by a value of pathlossReferenceLinking
If the UE
   is not provided pathlossReferenceRS or SRS-PathlossReferenceRS-Id,
   is not provided spatialRelationInfo, and
   is provided enableDefaultBeamPL-ForSRS, and
   is not provided coresetPoolIndex value of 1 for any CORESET, or is provided coresetPoolIndex value of 1 for all CORESETs, in ControlResourceSet and no codepoint of a TCI field, if any, in a DCI format of any search space set maps to two TCI states [TS 38.212] the UE determines a RS resource index q_{d} providing a periodic RS resource configured with qcl-Type set to ‘typeD’ in
   the TCI state or the QCL assumption of a CORESET with the lowest index in the active DL BWP, if CORESETs are provided in the active DL BWP of serving cell c
   the active PDSCH TCI state with lowest ID [TS 38.214] in the active DL BWP, if CORESETs are not provided in the active DL BWP of serving cell c
For the SRS power control adjustment state for active UL BWP b of carrier f of serving cell c and SRS transmission occasion i
   h_{p,f,c}(i,l)=f_{b,f,c}(i,l), where f_{b,f,c}(i,l) is the current PUSCH power control adjustment state, if srs-PowerControlAdjustmentStates indicates a same power control adjustment state for SRS transmissions and PUSCH transmissions; or

$${h}_{b , f , c} ( i ) = {h}_{b , f , c} ( i - {i}_{0} ) + {\sum }_{m = 0}^{𝒞 ( {s}_{i} ) - 1} {δ}_{SRS , b , f , c} ( m )$$

if the UE is not configured for PUSCH transmissions on active UL BWP b of carrier f of serving cell c, or if srs-PowerControlAdjustmentStates indicates separate power control adjustment states between SRS transmissions and PUSCH transmissions, and if tpc-Accumulation is not provided, where
The δ_{SRS,b,f,c} values are given in Table 1
δ_{SRS,b,f,c}(m) is jointly coded with other TPC commands in a PDCCH with DCI format 2_3

$${\sum }_{m = 0}^{𝒞 ( {S}_{i} ) - 1} {δ}_{SRS , b , f , c} ( m )$$

is a sum of TPC command values in a set Sᵢ of TPC command values with cardinality [symbol] (Sᵢ) that the UE receives between K_{SRS}(i−i₀)−1 symbols before SRS transmission occasion i−i₀ and K_{SRS}(i) symbols before SRS transmission occasion i on active UL BWP b of carrier f of serving cell c for SRS power control adjustment state, where i₀>0 is the smallest integer for which K_{SRS}(i−i₀) symbols before SRS transmission occasion i−i₀ is earlier than K_{SRS}(i) symbols before SRS transmission occasion i
if the SRS transmission is aperiodic, K_{SRS}(i) is a number of symbols for active UL BWP b of carrier f of serving cell c after a last symbol of a corresponding PDCCH triggering the SRS transmission and before a first symbol of the SRS transmission
if the SRS transmission is semi-persistent or periodic, K_{SRS}(i) is a number of K_{SRS,min} symbols equal to the product of a number of symbols per slot,

$${N}_{symb}^{slot} ,$$

and the minimum of the values provided by k2 in PUSCH-ConfigCommon for active UL BWP b of carrier f of serving cell c
If the UE has reached maximum power for active UL BWP b of carrier f of serving cell c at SRS transmission occasion i−i₀ and

$${\sum }_{m = 0}^{𝒞 ( {s}_{i} ) - 1} {δ}_{SRS , b , f , c} ( m ) \geq 0 ,$$

then h_{p,f,c}(i)=h_{p,f,c}(i−i₀)
If UE has reached minimum power for active UL BWP b of carrier f of serving cell c at SRS transmission occasion i−i₀ and

$${\sum }_{m = 0}^{𝒞 ( {S}_{i} ) - 1} {δ}_{SRS , b , f , c} ( m ) \leq 0 ,$$

then h_{b,f,c}(i)=h_{p,f,c}(i−i₀)
If a configuration for a P_{O_SRS,b,f,c}(qₛ) value or for a α_{SRS,b,fc}(qₛ) value for a corresponding SRS power control adjustment state/for active UL BWP b of carrier f of serving cell c is provided by higher layers

$${h}_{b , f , c} ( k ) = 0 , k = 0 , 1 , … , i$$

$$Else$$

$${h}_{b , f , c} ( 0 ) = Δ {P}_{rampup , b , f c} + {δ}_{msg 2 , b , f , c}$$

where
m_{sg2,b,f,c} is the TPC command value indicated in the random access response grant corresponding to the random access preamble that the UE transmitted on active UL BWP b of carrier f of the serving cell c, and

$$Δ {P}_{rampup , b , f c} = min [ \begin{matrix}max ( \begin{matrix}0 , \\ {P}_{CMAX , f , c} - ( {P}_{O \_ SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} ) )\end{matrix} ) , \\ Δ {P}_{rampuprequested , b , f c}\end{matrix} ] ;$$

Where ΔP_{rampuprequested,b,fc} is provided by higher layers and corresponds to the total power ramp-up requested by higher layers from the first to the last preamble for active UL BWP b of carrier f of the serving cell c.
h_{b,f,c}(i)=δ_{SRS,b,f,c}(i) if the UE is not configured for PUSCH transmissions on active UL BWP b of carrier f of the serving cell c, or if srs-PowerControlAdjustmentStates indicates separate power control adjustment states between SRS transmissions and PUSCH transmissions, and tpc-Accumulation is provided, and the UE detects a DCI format 2_3 K_{SRS,min} symbols before a first symbol of SRS transmission occasion i, where absolute values of δ_{SRS,b,f,c} are provided in Table 1
if srs-PowerControlAdjustmentStates indicates a same power control adjustment state for SRS transmissions and PUSCH transmissions, the update of the power control adjustment state for SRS transmission occasion i occurs at the beginning of each SRS resource in the SRS resource set qₛ; otherwise, the update of the power control adjustment state SRS transmission occasion i occurs at the beginning of the first transmitted SRS resource in the SRS resource set qₛ.

If a UE transmits SRS based on a configuration by SRS-PosResourceSet on active UL BWP b of carrier f of serving cell c, the UE determines the SRS transmission power P_{SRS,b,f,c}(i, qₛ) in SRS transmission occasion i as

$${P}_{SRS , b , f , c} ( i , {q}_{s} ) = min \{ \begin{matrix}{P}_{CMAX , f , c} ( i ) , \\ {P}_{O \_ SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} )\end{matrix} \} [ dBm ]$$

where,
P_{O_SRS,b,f,c}(qₛ) and α_{SRS,b,f,c}(qₛ) are provided by p0-r16 and alpha-r16 respectively, for active UL BWP b of carrier f of serving cell c, and SRS resource set qₛ is indicated by SRS-PosResourceSetId from SRS-PosResourceSet, and
PL_{b,f,c}(q_{d}) is a downlink pathloss estimate in dB calculated by the UE, in case of an active DL BWP of a serving cell c, using RS resource indexed q_{d} in a serving or non-serving cell for SRS resource set qₛ [TS 38.214]. A configuration for RS resource index q_{d} associated with SRS resource set qₛ is provided by pathlossReferenceRS-Pos
   if a ssb-IndexNcell is provided, referenceSignalPower is provided by ss-PBCH-BlockPower-r16
   if a dl-PRS-ResourceId is provided, referenceSignalPower is provided by dl-PRS-ResourcePower

If the UE determines that the UE is not able to accurately measure PL_{b,f,c}(q_{d}), or the UE is not provided with pathlossReferenceRS-Pos, the UE calculates PL_{b,f,c}(q_{d}) using a RS resource obtained from the SS/PBCH block of the serving cell that the UE uses to obtain MIB

The UE may indicate a capability for a number of pathloss estimates that the UE can simultaneously maintain for all SRS resource sets provided by SRS-PosResourceSet in addition to the up to four pathloss estimates that the UE maintains per serving cell for PUSCH/PUCCH transmissions and for SRS transmissions configured by SRS-Resource.

TABLE 1
Mapping of TPC Command Field in DCI format 2_3 to
absolute and accumulated δ_{SRS, b, f , c} values

| TPC Command | Accumulated | Absolute |
|---|---|---|
| Field | δ_{SRS, b, f , c} [dB] | δ_{SRS, b, f , c} [dB] |
| 0 | −1 | −4 |
| 1 | 0 | −1 |
| 2 | 1 | 1 |
| 3 | 3 | 4 |

In particular, a pathloss (PL) reference for SRS transmission can be an SSB or a periodic CSI-RS from the serving cell. For an SRS for positioning, a PL reference can be additionally a neighbor cell SSB or a DL positioning reference signal (DL PRS).

Radar (originally an acronym for “Radio Detection And Ranging”) is a system based on electromagnetic waveforms for detection of objects and determination of their physical characteristics such as location/range, velocity/speed, angle, elevation, and so on. Basically, a radio wave as a sounding waveform is transmitted by a radar Tx antenna, hits the object, and reflections of the wave return from the object to the radar. The radar Rx antenna receives the reflections, which are then analyzed by a data processor to determine the target object's physical characteristics.

Radars usually operate with waveform reflection with (very) low received power levels. Therefore, a key parameter for radar performance is the transmitted and received power levels with which the radar can achieve desired detection performance. The radar received power is usually captured by the following formulas, known as the “radar equation”:

$${P}_{r} = \frac{{P}_{t} {G}_{t} {G}_{r} σ {c}^{2}}{{( 4 π )}^{3} {f}^{2} {R}^{4}} ,$$

where Pₜ is the transmit power, Pᵣ is the received power, Gₜ is the Tx antenna gain, Gᵣ is the Rx antenna gain, σ with the units of square meters (m²) is the radar cross section (RCS) that captures the target's scattering characteristics, c is the speed of light, f is the carrier frequency for the radar sounding waveform, and R is the target's range (relative distance from the radar).

Radars are broadly categorized into two groups: Mono-static radars with a single antenna shared for radar Tx and Rx, and bi-static radars with separate Tx antenna and Rx antenna. Selection of a mono-static vs. bi-static radar can depend on the implementation choice, but is also a function of the operating frequency band. For example, for mmWave radar (i.e., a radar operating in the mmWave frequency band), there can be a large overlap between the transmitted radar waveform and the received reflections, especially for target object in close proximity of the radar, a phenomenon referred to as “leakage” or self-interference. In such cases, selection of separate Tx and Rx antennas appears to be crucial for radar operation.

Various kinds of sensing/sounding waveform can be used for radar operation. Generally, a single-carrier sinusoidal waveform in the form of A(t) sin[2π(t)+φ(t)] is used for radar sounding, that is generated by a local oscillator (LO). Various kinds of sensing/sounding waveform can be used for radar operation. Generally, a single-carrier sinusoidal waveform in the form of A(t) sin [2πf (t)+φ(t)] is used for radar sounding, that is generated by a local oscillator (LO). Herein, A(t) and f (t) and (t) are amplitude, frequency, and phase of the sensing/sounding waveform, all of which can be time-varying based on the waveform design, as discussed next.

Two most notable categories for radar waveforms include: pulse sounding waveform (accordingly, a pulse radar) and continuous-wave sounding waveform (accordingly, a continuous-wave radar). A pulse sounding waveform has an “on/off” or “pulse” shape, wherein the radar transmits a sounding waveform for a period of time and then switches to the “silent/listen” mode for another (extended) period of time wherein the radar does not transmit. During the radar transmission or “on” time period of a pulse radar, the UE still transmits a sinusoidal waveform, but most/all radar detection procedures are based on the pulse shape including the on/off time periods. In principle, a pulse waveform can be considered as amplitude modulation (AM) of the sinusoidal waveform based on a pulse shape. On the other hand, a continuous-wave (CW) radar continuously transmits a radar waveform without any on/off time pattern. For a CW radar, other waveform parameter such as frequency (frequency modulation or “FM”) or phase (phase modulation or “PM”) can be used, leading to FMCW radar or PMCW radar (a.k.a., phase code modulation (PCM) radar), respectively. Other modulation types include polarization modulation, noise (random) function modulation, and so on.

Accordingly, a pulse radar is more suitable for a mono-static radar architecture (although it can be used equally well for bi-static radar architecture), and a CW radar can be only used for bi-static radar architecture since a CW radar needs to continuously transmit a sounding waveform and receive the corresponding reflections.

For the case of pulse radar, the radar transmits a periodic, high-power, short “pulse”, wherein the amplitude A(t) is a square-wave signal shape with a logical “one” for a short time and zero otherwise (during waiting mode). Once the radar transmission period is completed, the radar goes to silent/listen mode for a long time window (e.g., with a length T>>pulse duration), during which the radar samples the received signals at the Rx antenna to determine reflection or echoes of the target(s). Accordingly, the radar determines the distance/range ‘R’ to the target object based on the two-way time difference ‘t’ until observing an Rx pulse (i.e., the reflection of the Tx pulse from the object received at the radar) using the formula R=(c·t)/2, wherein ‘c’ is the speed of light.

For uninterrupted operation of radar and tracking of the target's location, the pulse radar keeps transmitting/repeating the pulse shape with a periodicity. The time ΔT between two radar Tx pulses is known as the pulse repetition interval (PRI) and is also referred to as the “slow” time scale of the radar operation. Accordingly, a pulse repetition frequency (PRF) is defined as F_s=1/AT. For correct operation of the pulse radar, it is essential that reflections of a Tx pulse associated with a target are received before the next Tx pulse transmission, otherwise the target's range will be wrongly determined by the pules radar. Therefore, a target range is unambiguously detected if the target distance/range to the pulse radar is less than c/(2F_s). The parameter c/(2F_s) is referred to as the maximum unambiguous range interval for the pulse radar and is one of the key metrics for pulse radar performance. For example, for a pulse radar with PRF of F_s=10 mega-Hertz (MHz), the range resolution is around 15 meters (m).

In addition, it is possible to perform time diversity techniques for radar detection, referred to as “pulse integration”, wherein reflections of a same target corresponding to multiple Tx pulses are coherently combined to increase the SINR for target detection.

To determine the target's location/range with a given resolution/granularity and also to determine the target's velocity/speed, the radar samples the signals received at the Rx antenna during the Rx time window to detect reflections/echoes from target(s). The resolution or granularity of range detection by the pulse radar is based on how fast the radar can sample during the Rx window. Accordingly, the time Δt between two samples is known as the sampling period and is also referred to as the “fast” time scale. Accordingly, the pulse radar's sampling rate is defined as f_s=1/Δt. The pulse radar can achieve a range sampling resolution of c/(2f_s), i.e., the radar is able to determine UE's range to belong to a “range bin” of size c/(2f_s). Based on the PRI or PRF parameters described earlier for the “slow” time scale, the radar can define such range bins until a max range of c/(2F_s). For example, for a pulse radar with sampling rate of f_s=1 GHz, the range resolution is around 15 cm.

For determination of target's speed/velocity, it is noted that target's motion with a speed of v m/second (sec) leads to a Doppler frequency change given by the formula f_d=(v/c) f_c, where f_c is the carrier frequency of the Tx pulse. For such determination, it is common in radar technology to record Rx samples in a two-dimensional grid, wherein a horizontal axis corresponds to the slow-time or pulse index, and the vertical axis corresponds to fast-time or range bin index. Then, the pulse radar can determine the corresponding Doppler frequency change for a target in a given range bin by applying discrete Fourier transform (DFT) (or fast Fourier transform, “FFT”) to the horizontal axis for each range bin, so that a new two-dimensional grid is formed, where the vertical axis still corresponds to fast-time or range bin index, but the horizontal axis now corresponds to the frequency domain or “Doppler bins”. The pulse radar then determines the target's velocity based on the detected Doppler bin.

It is noted that in the case of a MIMO radar (as described next), such two-dimensional grids are extended to a three-dimensional grid/cube, where the third dimension corresponds to the antenna index or alternatively target's angular information.

To determine target's spatial information such as target's angle (or elevation) compared to the radar, the radar can use multiple antenna operation. A MIMO radar can use the antenna array steering vector to generate beams towards different directions or angles. The radar can determine the target's angle based on the angle of arrive (AoA) of the Rx beam with highest received power. The angular resolution is based on the size of FFT spatial bins.

A continuous-wave radar (CW radar) continuously generates a high frequency signal, and continuously receives and processes a flow of incoming Rx signals from the reflections coming back to the receiver. Without modulation, a CW radar can correctly determine the speed of moving targets using frequency shift caused by Doppler. However, there will not be a time reference to enable a determination of the range of the target. A modulated CW radar can facilitate range determination as well, since it provides time references in the transmitted/received signals to be able to determine extra information such as range.

A frequency modulated continuous wave (FMCW) radar, which is very common for vehicular applications, is based on a voltage controlled oscillator (VCO) that produces a chirp with a frequency change of bandwidth B in a period Tp. The chirp can be a linear or quadratic chirp, such as an up-chirp only, or a linear-triangular frequency chirp with an up-chirp and a down-chirp.

A phase modulated continuous wave (PMCW) radar uses a sequence of bits to perform binary phase modulation on a continuous wave, so that a ‘0’ is mapped to a 0-degree phase shift and a ‘1’ is mapped to a 180-degree phase shift (i.e., a binary phase shift key or “BPSK” operation). In principle, a PMCW radar is similar to a pulse radar, but with sequences (a.k.a., “codes”) instead of pulses. Therefore, the sequence of phase shifts depends on the use of certain sequences with special properties, such as auto-correlation properties. Various sequences can be considered for a PMCW such as complementary Golay sequences, M-sequences, Barker sequence, and Almost Perfect Auto-Correlation Sequences (APAS), and so on. In addition to high range resolution with low energy consumption and low implementation complexity, a benefit of PMCW is that the sequence can be consider as an identity (ID), so that the radar can operate with very good interference robustness, identification, and security.

Radar received and detection performance is based on the detection algorithm used at the radar receiver processor. A common method for radar detection is to use a matched filter that correlates the radar's transmitted sounding waveform with the received reflection waveforms. Accordingly, most radar detections method involve comparison of the matched filter output with a threshold. Therefore, radar's detection performance is crucially based on the choice of the threshold. This leads to a statistical detection problem that is associated with a false alarm probability and a miss detection probability. In radar theory and practice, the Neumann-Pearson criterion is generally accepted as a method to maximize the SINR. According to this criterion, the false alarm probability is fixed at the acceptable level, F, and under this condition, the maximum detection probability, D, is estimated. The choice of the false alarm is based on the radar's knowledge of statistical information on wanted signals/targets, unwanted interference and/or environment background reflections (a.k.a., clutter), and receiver noise. In various scenarios, such statistical information may be only partially available or may be changing over time (e.g., due to change in the environment background/clutter). Therefore, robust and adaptive algorithms, such as constant false alarm rate (CFAR) detection methods, are widely used for radar detection and recognition that “learn” the clutter information over time and ensure a guaranteed performance regardless of the (changing) environment situation.

Throughout this disclosure, the term “communication” is used in a broad sense of sending/receiving/exchange of data/information or corresponding control/signaling, and can include transmission or reception of any DL or UL or SL channel or signal for one UE or a group of UEs.

Throughout this disclosure, the term “sensing” or “radar sensing” or “radar” is used in a broad sense of usage of electromagnetic waveforms, such as radio-frequency (RF) waveforms, to identify presence of object(s) and/or to determine corresponding physical features or attributes such as location, for example, in horizontal/vertical/spatial/angular domain, or velocity/speed, acceleration, and so on.

FIG. 1 illustrates an exemplary networked system utilizing communication and sensing according to various embodiments of this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a base station (BS) 101, a BS 102, and a BS 103. The BS 101 communicates with the BS 102 and the BS 103. The BS 101 also communicates with at least one Internet protocol (IP) network 130, such as the Internet, a proprietary IP network, or another data network.

The BS 102 provides wireless broadband access to the network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R1); a UE 115, which may be located in a second residence (R2); and a UE 116, which may be a mobile device (M) like a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G, LTE, LTE Advanced (LTE-A), WiMAX, WiFi, NR, or other wireless communication techniques.

Depending on the network type, other well-known terms may be used instead of “base station” or “BS,” such as node B, evolved node B (“eNodeB” or “eNB”), a 5G node B (“gNodeB” or “gNB”) or “access point”. For the sake of convenience, the term “base station” and/or “BS” are used in this disclosure to refer to network infrastructure components that provide wireless access to remote terminals. Also, depending on the network type, other well-known terms may be used instead of “user equipment” or “UE,” such as “mobile station” (or “MS”), “subscriber station” (or “SS”), “remote terminal”, “wireless terminal”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extent of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

Although FIG. 1 illustrates one example of a wireless network 100, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BS 101, 102, and/or 103 could provide access to other or additional external networks, such as external telephone networks or other types of data networks.

FIG. 2 illustrates an exemplary base station (BS) utilizing communication and sensing according to various embodiments of this disclosure. The embodiment of the BS 200 illustrated in FIG. 2 is for illustration only, and the BSs 101, 102 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 200 includes multiple antennas 280a-280n, multiple radio frequency (RF) transceivers 282a-282n, transmit (TX or Tx) processing circuitry 284, and receive (RX or Rx) processing circuitry 286. The BS 200 also includes a controller/processor 288, a memory 290, and a backhaul or network interface 292.

The RF transceivers 282a-282n receive, from the antennas 280a-280n, incoming RF signals, such as signals transmitted by UEs in the network 100. The RF transceivers 282a-282n down-convert the incoming RF signals to generate IF or baseband signals. The IF or baseband signals are sent to the RX processing circuitry 286, which generates processed baseband signals by filtering, decoding, and/or digitizing the baseband or IF signals. The RX processing circuitry 286 transmits the processed baseband signals to the controller/processor 288 for further processing.

The TX processing circuitry 284 receives analog or digital data (such as voice data, web data, e-mail, or interactive video game data) from the controller/processor 288. The TX processing circuitry 284 encodes, multiplexes, and/or digitizes the outgoing baseband data to generate processed baseband or IF signals. The RF transceivers 282a-282n receive the outgoing processed baseband or IF signals from the TX processing circuitry 284 and up-converts the baseband or IF signals to RF signals that are transmitted via the antennas 280a-280n.

The controller/processor 288 can include one or more processors or other processing devices that control the overall operation of the BS 200. For example, the controller/processor 288 could control the reception of forward channel signals and the transmission of reverse channel signals by the RF transceivers 282a-282n, the RX processing circuitry 286, and the TX processing circuitry 284 in accordance with well-known principles. The controller/processor 288 could support additional functions as well, such as more advanced wireless communication functions and/or processes described in further detail below. For instance, the controller/processor 288 could support beam forming or directional routing operations in which outgoing signals from multiple antennas 280a-280n are weighted differently to effectively steer the outgoing signals in a desired direction. Any of a wide variety of other functions could be supported in the BS 200 by the controller/processor 288. In some embodiments, the controller/processor 288 includes at least one microprocessor or microcontroller.

The controller/processor 288 is also capable of executing programs and other processes resident in the memory 290, such as a basic operating system (OS). The controller/processor 288 can move data into or out of the memory 290 as required by an executing process.

The controller/processor 288 is also coupled to the backhaul or network interface 292. The backhaul or network interface 292 allows the BS 200 to communicate with other devices or systems over a backhaul connection or over a network. The interface 292 could support communications over any suitable wired or wireless connection(s). For example, when the BS 200 is implemented as part of a cellular communication system (such as one supporting 6G, 5G, LTE, or LTE-A), the interface 292 could allow the BS 200 to communicate with other BSs over a wired or wireless backhaul connection. When the BS 200 is implemented as an access point, the interface 292 could allow the BS 200 to communicate over a wired or wireless local area network or over a wired or wireless connection to a larger network (such as the Internet). The interface 292 includes any suitable structure supporting communications over a wired or wireless connection, such as an Ethernet or RF transceiver.

The memory 290 is coupled to the controller/processor 288. Part of the memory 290 could include a RAM, and another part of the memory 290 could include a Flash memory or other ROM.

As described in more detail below, base stations in a networked computing system can be assigned as synchronization source BS or a slave BS based on interference relationships with other neighboring BSs. In some embodiments, the assignment can be provided by a shared spectrum manager. In other embodiments, the assignment can be agreed upon by the BSs in the networked computing system. Synchronization source BSs transmit OSS to slave BSs for establishing transmission timing of the slave BSs.

Although FIG. 2 illustrates one example of BS 200, various changes may be made to FIG. 2. For example, the BS 200 could include any number of each component shown in FIG. 2. As a particular example, an access point could include a number of interfaces 292, and the controller/processor 288 could support routing functions to route data between different network addresses. As another particular example, while shown as including a single instance of TX processing circuitry 284 and a single instance of RX processing circuitry 286, the BS 200 could include multiple instances of each (such as one per RF transceiver). Also, various components in FIG. 2 could be combined, further subdivided, or omitted and additional components could be added according to particular needs.

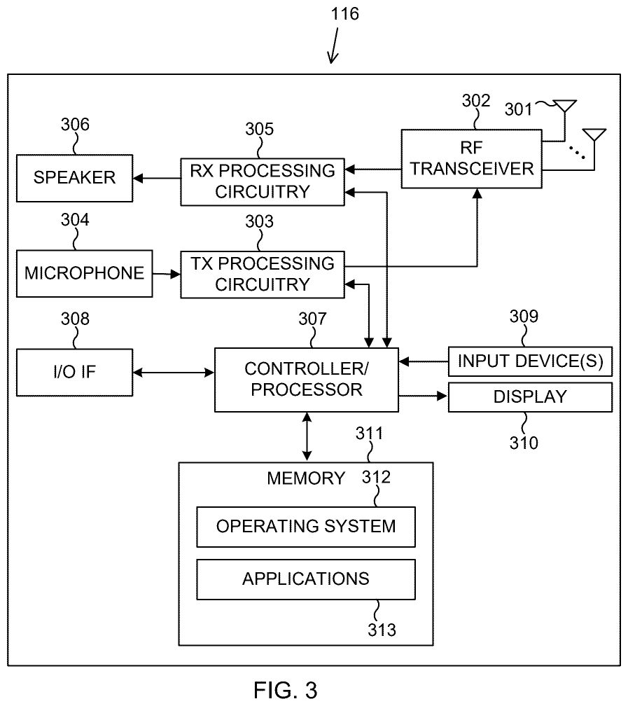

FIG. 3 illustrates an exemplary electronic device for communicating in the networked computing system utilizing communication and sensing according to various embodiments of this disclosure. The embodiment of the UE 116 illustrated in FIG. 3 is for illustration only, and the UEs 111-115 and 117-119 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes an antenna 301, a radio frequency (RF) transceiver 302, TX processing circuitry 303, a microphone 304, and receive (RX) processing circuitry 305. The UE 116 also includes a speaker 306, a controller or processor 307, an input/output (I/O) interface (IF) 308, a touchscreen display 310, and a memory 311. The memory 311 includes an OS 312 and one or more applications 313.

The RF transceiver 302 receives, from the antenna 301, an incoming RF signal transmitted by an gNB of the network 100. The RF transceiver 302 down-converts the incoming RF signal to generate an IF or baseband signal. The IF or baseband signal is sent to the RX processing circuitry 305, which generates a processed baseband signal by filtering, decoding, and/or digitizing the baseband or IF signal. The RX processing circuitry 305 transmits the processed baseband signal to the speaker 306 (such as for voice data) or to the processor 307 for further processing (such as for web browsing data).

The TX processing circuitry 303 receives analog or digital voice data from the microphone 304 or other outgoing baseband data (such as web data, e-mail, or interactive video game data) from the processor 307. The TX processing circuitry 303 encodes, multiplexes, and/or digitizes the outgoing baseband data to generate a processed baseband or IF signal. The RF transceiver 302 receives the outgoing processed baseband or IF signal from the TX processing circuitry 303 and up-converts the baseband or IF signal to an RF signal that is transmitted via the antenna 301.

The processor 307 can include one or more processors or other processing devices and execute the OS 312 stored in the memory 311 in order to control the overall operation of the UE 116. For example, the processor 307 could control the reception of forward channel signals and the transmission of reverse channel signals by the RF transceiver 302, the RX processing circuitry 305, and the TX processing circuitry 303 in accordance with well-known principles. In some embodiments, the processor 307 includes at least one microprocessor or microcontroller.

The processor 307 is also capable of executing other processes and programs resident in the memory 311, such as processes for CSI reporting on uplink channel. The processor 307 can move data into or out of the memory 311 as required by an executing process. In some embodiments, the processor 307 is configured to execute the applications 313 based on the OS 312 or in response to signals received from gNBs or an operator. The processor 307 is also coupled to the I/O interface 309, which provides the UE 116 with the ability to connect to other devices, such as laptop computers and handheld computers. The I/O interface 309 is the communication path between these accessories and the processor 307.

The processor 307 is also coupled to the touchscreen display 310. The user of the UE 116 can use the touchscreen display 310 to enter data into the UE 116. The touchscreen display 310 may be a liquid crystal display, light emitting diode display, or other display capable of rendering text and/or at least limited graphics, such as from web sites.

The memory 311 is coupled to the processor 307. Part of the memory 311 could include RAM, and another part of the memory 311 could include a Flash memory or other ROM.

Although FIG. 3 illustrates one example of UE 116, various changes may be made to FIG. 3. For example, various components in FIG. 3 could be combined, further subdivided, or omitted and additional components could be added according to particular needs. As a particular example, the processor 307 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

### E-1) Beam Management for Radar Sensing Reference Signal:

In one embodiment, a beam or spatial filter for radar sensing transmission or reception can be per UE selection based on the sensing application, with possible gNB configuration of a (n) valid/allowed set of beams/spatial filters, or gNB indication of an adjustment to the UE-selected beam, or assistance information from gNB or other UEs to help the UE select the beam.

One motivation for such UE-based selection of beam/spatial filter for radar sensing transmission/reception is that, for various radar sensing applications, the gNB may not be aware of a suitable/best beam for transmission or reception, or in some cases a beam/spatial filter for radar sensing transmission or reception is not aligned with (e.g., QCL with) a gNB Tx beam of any DL reference signal, or a corresponding UE Rx beam for reception of such DL RS. For example, a spatial relation info configuration for an SRS is based on an SSB associated with serving cell or neighbor cell, or a serving cell CSI-RS, or a DL-PRS, all of which are mainly targeting UE-gNB/TRP directions and may be less relevant for radar sensing applications. In another example, a sidelink (SL) CSI-RS is targeted at inter-UE transmission or reception, however, there is currently no spatial relation or TCI state configuration available for a sidelink (SL) CSI-RS. Accordingly, current beam management does not appear to provide a suitable support for a radar sensing RS.

In one realization, the UE selects a Tx beam/spatial relation for a sensing RS, such as SRS for sensing, or SL CSI-RS for sensing, or a new radar RS (RRS). In one example, the UE selects a Tx beam for a radar RS based on the radar sensing application or category. For example, the UE determines a Tx beam/spatial relation for the sensing RS based on radar sensing characteristics, such as a target/maximum/minimum field of view (FoV), angular resolution or accuracy, AoA or AoD resolution or accuracy, number/density/geographical distribution of target objects for sensing in terms of location, as well as any beam steering or beam sweeping property and a corresponding periodicity or repetition. In one example, there can be a linkage between a Tx beam/spatial relation for a sensing RS and a radar sensing category or characteristics, wherein the linkage can be based on gNB configuration or UE implementation, or a combination thereof.

In one example, the gNB configures a set of (one or) multiple valid/allowed beam(s) or spatial relation(s) for sensing RS, and the UE selects a beam for a sensing RS from the configured set. For example, a valid/allowed set of beams can capture beam directions in which the UE will not cause interference to other UEs by its radar sensing transmission. For example, for the case when some time/frequency for resources for radar sensing transmission are overlapping with time/frequency resources for DL/UL/SL communication and sensing of at least some other UEs, spatial separation can be provided by restricting the set of valid/allowed beam to those directions in which other UEs' communication will incur little/no interference from the UE's radar sensing transmission.

In another example, the gNB may provide assistance information to the UE to select a beam/spatial relation for a sensing RS, e.g., by providing a set of beam directions for DL/UL/SL communication (or even radar sensing) transmissions or receptions corresponding to nearby UEs, so that the UE can select its radar sensing Tx beam accordingly. For example, the UE can use such assistance information to selects beam directions for radar sensing that is less/not impacted by other UE's interference, or can take other UE's interference into account when making measurements or attempting signal detections.

In another example, other UEs such as by neighbor UEs can provide assistance information (or even configuration of valid/allowed set of beams) for a UE's selection of beam(s)/spatial relation(s) for sensing RS. For example, a second (neighbor) UE can provide such indication using a sidelink control information (SCI) to the UE. In one example, the neighbor UE can use its own sensing measurements or sensing results to determine suitable beams for radar sensing by other UEs, and can provide such determined suitable beams as assistance information to the UE. In another example, a neighbor UE can provide its original sensing measurements or sensing results (in the raw form or based on some predetermined processing) as assistance information to the UE, using a SCI or possibly as a form of feedback on the sidelink feedback control channel (SFCI) over a physical sidelink feedback channel (PSFCH).

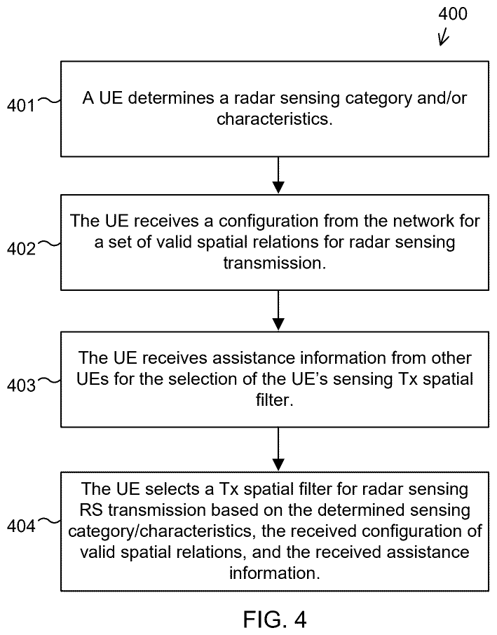

FIG. 4 shows an example flowchart for UE-based selection of Tx beam for radar sensing transmission based on the sensing application category, gNB configuration of valid beams, and other neighbor UEs' assistance information, according to embodiments of the present disclosure. In the process 400, a UE determines a radar sensing category and/or characteristics (step 401). The UE receives a configuration from the network for a set of valid spatial relations for radar sensing transmission (step 402). The UE receives assistance information from other UEs for the selection of the UE's sensing Tx spatial filter (step 403). The UE selects a Tx spatial filter for radar sensing RS transmission based on the determined sensing category/characteristics, the received configuration of valid spatial relations, and the received assistance information (step 404).

In step 401, the determination can be based on target angular resolution and accuracy. In step 403, assistance information can include/be based on other UEs' sensing measurements.

In one realization, UE can select an Rx beam/spatial relation/TCI state for a radar sensing reception, wherein such selection can be (at least in part) based on a configuration or indication from gNB or other (neighbor) UEs. In one example, the UE uses a same Rx beam for radar sensing reception as a Tx beam used for radar sensing transmission. In another example, the UE may use a second different antenna panel/array for radar sensing reception compared to a first antenna panel/array for radar sensing transmission, so the UE may need to perform an adjustment on the Rx beam for radar sensing reception compared to the Tx beam used for radar sensing transmission. In one example, the UE can determine such adjustment based on UE implementation, while in another example, such an Rx beam adjustment can be (at least in part) based on assistance information received from the gNB or other (neighbor UEs). For example, for the case that radar sensing target is based on non-line-of-sight (NLOS) reflections and measurements, assistance information from the gNB or other UEs can be beneficial in determining an Rx beam (and even Tx beam) for radar sensing or for adjusting the Rx beam compared to the Tx beam.

### E-2) Power Control for Radar Sensing RS:

In one embodiment, a transmission power for radar sensing RS, such as sensing SRS or SL CSI-RS for sensing, can be semi-statically configured or can be determined based on a semi-statically configured received power for sensing along with full or partial pathloss compensation.

In one realization, the UE is configured by higher layer signaling with a transmission power for radar sensing. That is, the UE is directly and explicitly provided the transmission power level for radar sensing. In one example, such transmission power level can be based on a linkage with an application category such as based on radar sensing characteristics and performance requirements for target/maximum/minimum range or velocity or corresponding resolution or accuracy. For example, the UE indicates a request for a sensing category from one of four categories {0,1,2,3}, and a sensing transmission power level is configured based on the indicated sensing category.

In another realization, a transmission power level for radar sensing is not directly and explicitly configured to the UE, rather the UE determined the sensing transmission power based on a sensing power control formula. For example, the UE is provided with a target received power for the sensing RS, so the UE needs to determine a corresponding transmission power level to achieve the target received power. In one example, the UE uses a generic formula such as the “radar equation” to determine a transmission power level, irrespective of the Tx/Rx beam for radar sensing RS or a corresponding pathloss reference measurement. Such determination can be based on a set of target/minimum/maximum/average values corresponding to the sensing parameters, such as the target/minimum/maximum/average range, target/minimum/maximum/average values for radar cross section (RCS) corresponding to target objects, and so on.

In another example, the UE is provided by higher layer signaling with a sensing pathloss reference such as a sidelink SSB (S-SSB, or S-SS/PSBCH) or a SL CSI-RS, wherein the UE measures the sensing pathloss reference and determines a (possibly L1/L3-filtered) pathloss estimate corresponding to the sensing PL reference (can be still using the “radar equation”). A configuration of the sensing PL reference can be based on Tx/Rx beams selected/determined/configured for the sensing transmission (as described in Embodiment E-1). The UE can be additionally provided by higher layers with a pathloss compensation factor, wherein the UE can partially or fully compensate the corresponding pathloss estimated value.

In yet another example, in case of a sensing transmission power control formula, the determined sensing transmission power is maintained across all radar sensing transmission occasions (as long as there is no re-configuration to the corresponding parameters). In another example, there can be a dynamic change to the sensing transmission power across different sensing transmission occasions. Such power variation can correspond to different range bins or different velocity bins, or different angular bins, or different RCS values, and so on, or can be for increased sensing performance such as increased accuracy or refined resolution. Such a power variation can be determined by UE implementation or based on transmit power control (TPC) command by the gNB.

In one realization, when a UE's radar sensing transmission is simultaneous or overlapping in time with a UL/SL transmission by the UE, and when a same power amplifier/RF chain is shared for communication and sensing (for example, for both the communication module and the radar sensing module) or when a total transmission power level for the UE is upper bounded based on regulatory requirements, the UE needs to perform power sharing between communication and sensing to meet the total power limit. In such cases, the UE can do power scaling (including zero power allocation, resulting in dropping) to the communication or sensing, possibly based on a priority order. In one example, an UL/SL communication is always prioritized over radar sensing. In another example, a radar sensing transmission is always prioritized over communication. In yet another example, a priority level for radar sensing versus communication is based on different priority levels for different UL/SL reference signals or channels. For example, a radar sensing RS can have a same priority level as for a legacy SRS transmission. In another example, the UE performs an equal power backoff for both sensing and communication. In another example, the UE applies a proportional power backoff to the radar sensing transmission and the UL/SL transmission based on their originally determined transmission power levels (i.e., without any scaling) and/or based on their relative priority. In one example, a power scaling or dropping only applies to the symbols overlapping between communication and sensing, while in another example, the power scaling or dropping can be applied to the entire transmission(s).

In another embodiment, transmit power control for sensing RS can be performed based on whether the sensing resource pool is shared between multiple UEs. In one example, sensing resources are solely allocated to the UE, and transmit power control for sensing RS can be performed as described in previous embodiments. In another example, sensing resource pools are shared among different UEs so that UEs can access the allocated resource pools for sensing without coordination from the BS. When allocated shared resource pools, the UE can perform energy sensing on the allocated time/frequency resource pools and determine its transmit power based on the maximum transmit power set by the BS, the sensed energy level, and the minimum transmit power calculated from the radar equation.

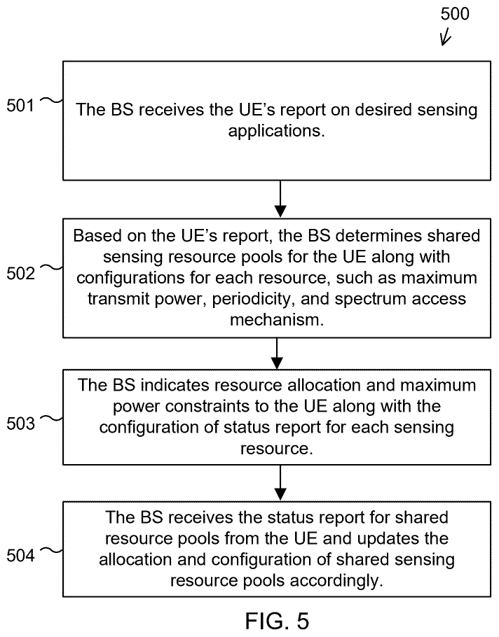

FIG. 5 shows an example BS-side flowchart for UE transmit power control on shared resource pools, according to embodiments of the present disclosure. In the process 500, at operation 501, the BS receives the UE's report on desired sensing application. In one example, the sensing application can be reported in terms of sensing KPIs, such as accuracy, resolution, periodicity, coverage, and directionality, etc. In another example, sensing application can be reported via predefined indices for sensing applications. At operation 502, the BS determines the share resource pools as well as the corresponding configurations for the UE based on the UE's report. The configurations of shared resource pools can include time/frequency resource allocation, maximum transmit power, periodicity, maximum percentage of occupation and spectrum access mechanism (e.g., ALOHA or carrier sense multiple access (CSMA) types of schemes) for each resource in the shared resource pools. Different UEs with different target applications can be allocated with different sensing resource pools and different configurations. In one example, UEs at different locations can be allocated different sensing resource pools due to resource availability. In another example, maximum transmit power constraints can be different for UEs even they share the same resource pools, e.g., a UE performing directional motion tracking and a UE performing omnidirectional presence detection. At operation 503, the BS indicates resource allocation and maximum transmit power constraints to the UE along with the configuration of status report for each sensing resource pool. The configuration of status report for sensing resource pools will be discussed in a separate embodiment. At operation 504, the BS receives the status report for shared resource pools from the UE and updates the allocation and configuration of shared sensing resource pools accordingly.

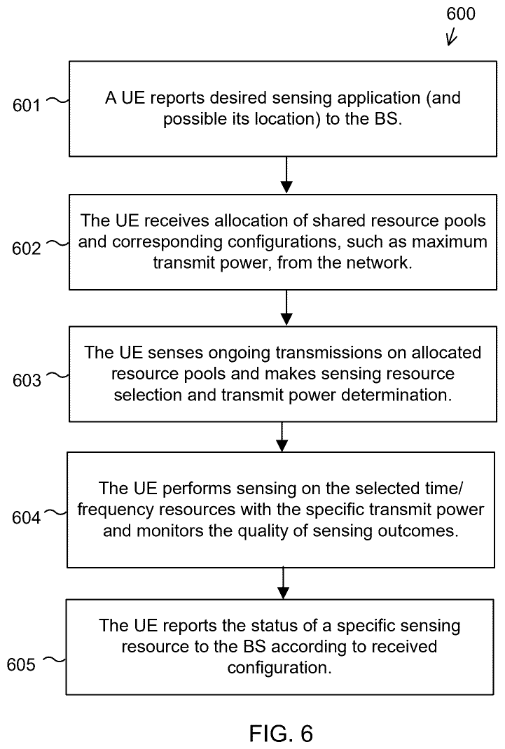

FIG. 6 shows an example UE-side flowchart for UE transmit power control on shared resource pools, according to embodiments of the present disclosure. In the process 600, at operation 601, the UE reports desired sensing application (and possible the UE's location) to the BS. In one example, the sensing application can be reported in terms of sensing KPIs, such as accuracy, resolution, periodicity, coverage, and directionality, etc. In another example, sensing application can be reported via predefined indices for sensing applications. At operation 602, the UE receives the allocation of shared resource pools and corresponding configurations for each resource from the BS. The configurations of shared resource pools can include time/frequency resource allocation, maximum transmit power, periodicity, maximum percentage of occupation and spectrum access mechanism (e.g., ALOHA or CSMA types of schemes) for each resource in the shared resource pools. The maximum transmit power constraints can be different for different UEs on different resources. At operation 603, the UE senses ongoing transmissions on the allocated resource pools and make sensing resource selection and transmit power determination. The UE can perform energy sensing based on the detection threshold configured by the BS or signal sensing and sequence detection to search the individual waveform from other UEs, or both. The UE can set the UE's transmit power based on the maximum power constraints set by the BS, the sensed energy level on the selected time/frequency resources, and the minimum transmit power calculated from the radar equation. For example, the UE can set the transmit power for sensing RS inversely proportional to the sensed energy level while satisfying the maximum and minimum transmit power constraint set by the BS and the radar equation. At operation 604, the UE performs sensing on the selected time/frequency resources with the specific transmit power and monitors the sensing outcome. At operation 605, the UE reports the status of a specific sensing resource to the BS according to received configuration from the BS.

In yet another embodiment, the UE can be configured to report the status of each allocated sensing resource to the BS. The status to be reported and their triggering condition are summarized as
Bad condition of sensing resource: this can happen when thresholds for energy/signal detection are too high so that the frequency where the UE can find a resource to access is below a threshold, when the frequency where the UE's sensing beam experiences blockage exceeds a threshold, or when the measured interference at the UE exceeds a threshold
Too strict maximum power constraint: this can happen when the signal-to-noise ratio of the returned signal is below a predefined threshold.

The UE will report the corresponding status to the BS once the report conditions are met. In one example, the BS can configure UL resources for the UE's status report. In another example, the UE can request UL resources from the BS for status report.

### E-3) Signaling and Information Exchange Between Radar and Communication:

In one embodiment, there can be a signaling, information exchange, or interaction between radar sensing and DL/UL/SL communication. According to this embodiment, radar sensing not only provides measurements and information for UE's higher layer applications, radar sensing also can provide information or assistance to communication procedures. Therefore, the UE can use radar sensing measurement reports or information to improve its communication performance. For example, the UE's radar sensing module can provide such information to the UE's communication module. Alternatively, the UE can use DL/UL/SL communication to assist UE's radar sensing.

In one example, when a UE determines certain objects (such as a wall, tree, building, etc.) that can cause blockage for communication, the UE can report such information to the gNB, so that gNB uses such information into account for the UE's beam management, including suitable beam determination, as well as reducing or avoiding link recovery procedure (a.k.a., beam failure recovery (BFR)) or radio link failure (RLF). In addition, such information may be used for other neighbor UEs as well. In another example, such information may be used for maximum permissible exposure (MPE) issue, which is common for higher bands such as FR2. A benefit of such approach is that, gNB is provided such information without any need for active sensing by the gNB (or as complementary to any gNB's active sensing) and by re-using acquired information from UE's radar sensing operation. Exchange of such information between UE and gNB can be based on, for example, a (new) uplink control information (UCI) that is carried on PUCCH or multiplexed on PUSCH.

In another example, once radar sensing by a first UE determines location of a second UE, the first UE can use the second UE's location for fast beam management such as determination of a good beam for SL SSB or SL CSI-RS, without any need for beam sweeping.

In yet another example, radar sensing information can be used for reduced CSI reporting overhead. For example, angular information acquired by radar sensing can be used for spatial compression or precoder selection in CSI feedback codebooks. For example, certain directions/angles/beams are included or excluded from CSI reporting feedback based on the radar sensing measurements. Additionally, radar measurements can be used to determine certain spatial correlation in various beam/angels/directions and thereby beneficial to CSI compression.

In one realization, legacy SRS for communication (such as for channel sounding) can be (re-) used for radar sensing purposes. In such a case, radar sensing can be considered to be “passive”, in the sense that the UE is not transmitting any dedicated radar sensing transmission, rather using reflections of existing SRS transmissions with legacy configuration to perform radar sensing operation. A benefit of this approach is reusing the time/frequency for both communication and sensing.

In another embodiment, the information on the UE beams, including communication/sensing beam indices and corresponding beam-specific measurements (e.g., RSRP and interference level) should be shared. In one example, the UE can feedback its selection of sensing beam to the BS to assists resource allocation. In another example, the blockage detected by the UE's sensing function can be shared with the UE's communication function to help selection of communication beams. For example, when the UE's sensing function detects that the received reflected power on a sensing beam exceeds a predetermined threshold, it can notify the UE's communication function that a potential blockage exists along the sensing beam direction so that the communication function can deprioritize the communication beam along this direction during beam training/selection. In another example, the UE can share the beam-specific RSRP measurements collected during SSB transmissions with its sensing function. The UE's sensing function can perform sensing by following the reverse order of the shared RSRP measurement collected along the corresponding direction. The sensing beam can also be selected based on other orders determined upon the shared RSRP measurements.

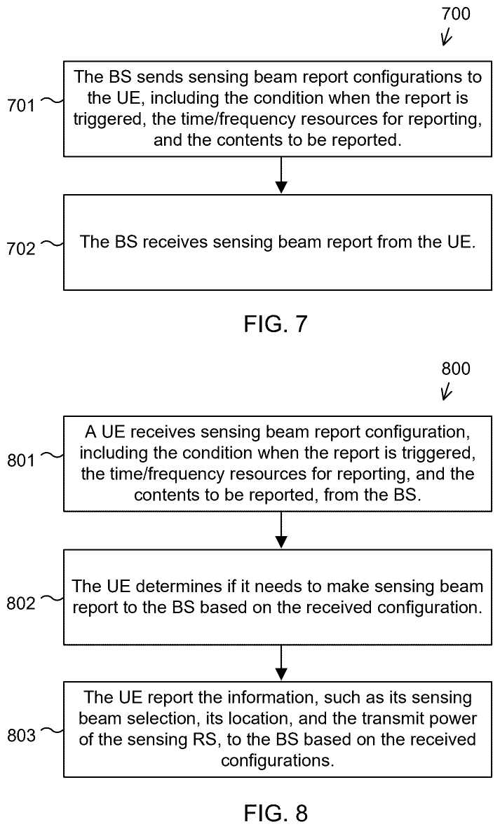

FIG. 7 shows an example BS-side flowchart for UE sensing beam selection report, according to embodiments of the present disclosure. In the process 700, at operation 701, the BS sends sensing beam report configuration to the UE, including the condition when the report is triggered, the time/frequency resources for reporting, and the contents to be reported. The configuration of sensing beam report can be either cell-specific or UE-specific and can be sent either along with sensing resource allocation or as a separate configuration. In one example, the sensing beam report can be periodically triggered. In another example, the sensing beam report can be aperiodically triggered when the UE′ location, sensing beam selection or transmit power for sensing RS changes. In yet another example, the UE can be configured to report when its transmit power is within a predefined range, or its selects beam along specific directions, or it is transmitting on specific time/frequency resources, or any combination of these conditions. The content of the sensing beam report can include the UE's beam selection for sensing RS, the UE's location, and the transmit power of the sensing RS. In one example, the UE's beam selection can be reported via the parameters of the selected beams, such as main-lobe direction, beamwidth, and directional gain, or via its index in a predefined codebook shared between the BS and the UE. At operation 602, the BS receives the sensing beam report from the UE and employ the received information to determine resource allocation for communications and sensing.

FIG. 8 shows an example UE-side flowchart for UE sensing beam selection report, according to embodiments of the present disclosure. In the process 800, at operation 801, the UE receives sensing beam report configuration from the BS, including the condition when the report is triggered, the time/frequency resources for reporting, and the contents to be reported. The configuration of sensing beam report can be either cell-specific or UE-specific and can be sent either along with sensing resource allocation or as a separate configuration. In one example, the sensing beam report can be periodically triggered. In another example, the sensing beam report can be aperiodically triggered when the UE′ location, sensing beam selection or transmit power for sensing RS changes. In yet another example, the UE can be configured to report when the UE's transmit power is within a predefined range, or the UE selects a beam along specific directions, or the UE is transmitting on specific time/frequency resources, or any combination of these conditions. The content of the sensing beam report can include the UE's beam selection for sensing RS, the UE's location, and the transmit power of the sensing RS. In one example, the UE's beam selection can be reported via the parameters of the selected beams, such as main-lobe direction, beamwidth, and directional gain, or via its index in a predefined codebook shared between the BS and the UE. At operation 802, the UE determines if the UE needs to make sensing beam report to the BS based on the received configuration. At operation 803, the UE reports the information, such as the UE's sensing beam selection, the UE's location, and the transmit power of the sensing RS, to the BS based on the received configurations.

In yet another embodiment, the transmit power of the sensing function and the communication function should be shared. In one example, the BS can share the transmit power of its downlink transmissions or other UEs' uplink transmissions with the UE so that the UE can utilize the communication signal for passive sensing. In another example, the UE can report its transmit power for sensing RS to the BS so that the BS can adjust the UE's transmit power for UL communications. For example, the requirements, such as accuracy and resolution, of sensing application can be met with transmit power below the preset maximum transmit power constraint, the UE can report the UE's transmit power of sensing RS to the BS, and the BS can increase the UE's transmit power for UL communications as long as the MPE constraint is met.

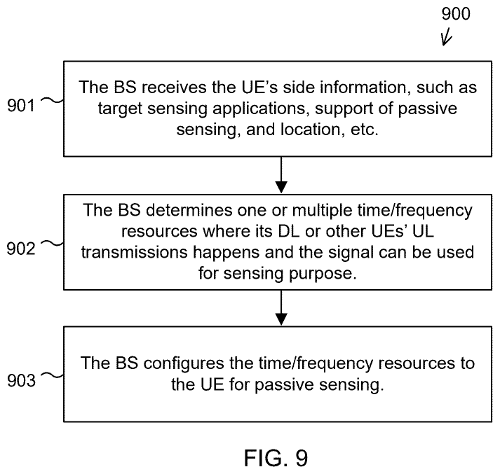

FIG. 9 shows an example BS-side flowchart for time/frequency resource configuration for passive sensing, according to embodiments of the present disclosure. In the process 900, at operation 901, the BS receives the UE's side information, such as target sensing applications, support of passive sensing, and location, etc. At operation 902, based on the received UE-side information, the BS determines one or multiple time/frequency resources where its DL or other UEs' UL transmissions happens, and the signal can be used for sensing purpose. For example, the BS can determine the time/frequency resources for the UE based on the UE's location, time duration and bandwidth where the downlink/uplink transmission happens, whether the transmission is directional, beamforming direction of the signal, types of sensing applications. The BS can configure multiple time/frequency resources to the UE and let the UE determine which one to use. The BS can also send the location of signal source and transmit power on each time/frequency resource to the UE along with this configuration. At operation 903, the BS configures the time/frequency resources to the UE for passive sensing.

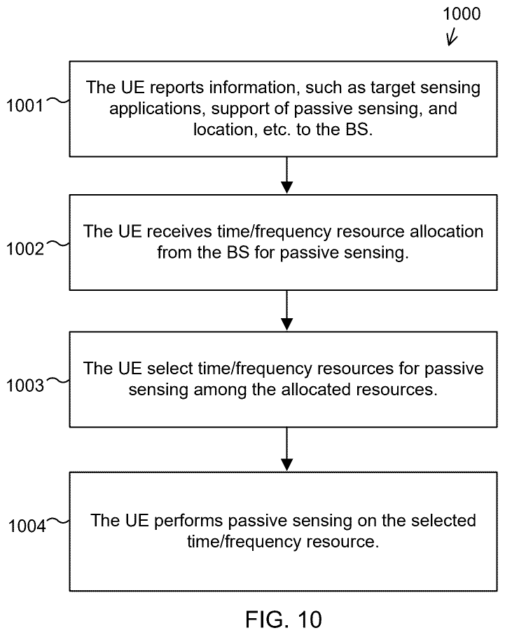

FIG. 10 shows an example UE-side flowchart for time/frequency resource configuration for passive sensing, according to embodiments of the present disclosure. In the process 1000, at operation 1001, the UE reports the information, such as target sensing applications, support of passive sensing, and location, etc. to the BS. At operation 1002, the UE receives time/frequency resource allocation for passive sensing from the BS. The UE could also receive the location of signal source and transmit power on each time/frequency resource from the BS along with this configuration. At operation 1003, the UE selects time/frequency resources for passive sensing among the allocated resources. When multiple resources are configured, the UE can select one or multiple resources for sensing RS transmissions according to target sensing application, the location of signal source, and transmit power, etc. At operation 1004, the UE performs passive sensing on the selected time/frequency resources.

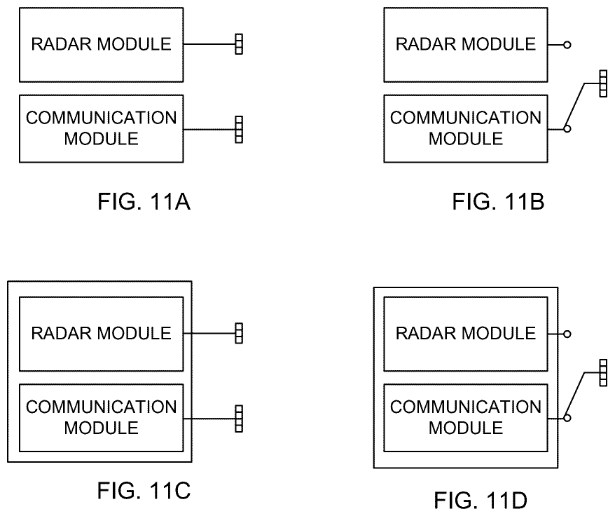

FIGS. 11A, 11B, 11C, and 11D diagrammatically illustrate separate antenna panels and a common antenna panel for wireless communication and radar in the UE 116 of FIG. 3. Independent operations of communication and radar on a UE may not be possible when the RF isolation between the wireless communication and radar is not sufficiently good. The radar transmission interference to the wireless communication signal reception can depend on the radar Tx power, the radar bandwidth, the radar Tx power spectral density, and the wireless communication system bandwidth that is interfered by the radar transmission. For directional radar and/or wireless communication beams, the radar interference level to the wireless communication DL reception can also be a function of the operating beams. Under this condition, simultaneous communication reception (transmission) and radar transmission (reception) may not be feasible due to the interference between the two systems.

FIGS. 11A and 11B show two possible architectures of UE with a wireless communication module and a radar module that may suffer from the inter-system interference problem due to the lack of RF isolation between the two systems. FIG. 11A illustrates an architecture with separate antenna panels/modules for the wireless communication module and the radar module, in which interference in the internal circuit and RF interference over the air may occur. FIG. 11B illustrates an architecture with a common antenna panel/module, in which interference within the switch may occur due to imperfect isolation. FIGS. 11C and 11D illustrate similar architectures for wireless communication and radar modules, but also depict the two modules being provided in a single housing, device, or functional unit.

The subject matter of this disclosure can be applicable to beyond 5G, 6G, or any wireless communication systems.

The disclosure pertains joint communication and radar sensing, wherein a UE is able to perform downlink/uplink/sidelink communication and also perform radar sensing by “sensing”/detecting environmental objects and their physical characteristics such as location/range, velocity/speed, elevation, angle, and so on. Radar sensing is achieved by sending a suitable sounding waveform and receiving and analyzing reflections or echoes of the sounding waveform. Such radar sensing operation can be used for applications and use-case such as proximity sensing, liveness detection, gesture control, face recognition, room/environment sensing, motion/presence detection, depth sensing, and so on, for various UE form factors. For some larger UE form factors, such as (driver-less) vehicles, trains, drones and so on, radar sensing can be additionally used for speed/cruise control, lane/elevation change, rear/blind spot view, parking assistance, and so on. Such radar sensing operation can be performed in various frequency bands, including mmWave/FR2 bands. In addition, with THz spectrum, ultra-high resolution sensing, such as sub-cm level resolution, and sensitive Doppler detection, such as micro-Doppler detection, can be achieved with very large bandwidth allocation, for example, on the order of several GHz or more.

The present disclosure provides designs for the support of joint communication and radar sensing. The disclosure aims for optimal signal design and processing block architecture that can be reused for both communication and sensing. In addition, sensing operation can be integrated into the frame structure and bandwidth configuration. Furthermore, a unified design can achieve coordination between BS-UE for uninterrupted communication, and UE-UE to minimize the impact of interference due to sensing.

One motivation is to support radar sensing operation in beyond 5G or in 6G, especially in higher frequency bands such as the ones above 6 GHZ, mmWave, and even Tera Hz (THz) bands. In addition, the embodiments can apply to various use cases and settings, such as frequency bands below 6 GHZ, eMBB, URLLC and IIoT and XR, mMTC and IoT, sidelink/V2X, operation in unlicensed/shared spectrum (NR-U), non-terrestrial networks (NTN), aerial systems such as drones, operation with reduced capability (RedCap) UEs, private or non-public networks (NPN), and so on.

The present disclosure relates to beyond 5G or 6G communication system to be provided for supporting one or more of: higher data rates, lower latency, higher reliability, improved coverage, and massive connectivity, and so on. Various embodiments apply to UEs operating with other RATs and/or standards, such as different releases/generations of 3GPP standards (including beyond 5G, 6G, and so on), IEEE standards (such as 802.11/15/16), and so forth.

Although this disclosure has been described with an exemplary embodiment, various changes and modifications may be suggested to one skilled in the art. It is intended that this disclosure encompass such changes and modifications as fall within the scope of the appended claims.

What is claimed is:

1. A user equipment (UE), comprising:
a memory;
a transceiver configured to receive information related to a sensing signal, the information including at least:
a time domain pattern to transmit or receive the sensing signal, and
one or more parameters related to:
a power to transmit the sensing signal, or
a spatial filter to transmit or receive the sensing signal; and
processing circuitry operably coupled to the transceiver and the memory, the processing circuitry configured to:
determine the sensing signal based on the information,
determine the spatial filter based on the one or more parameters, wherein the one or more parameters at least provide information related to sensing beam restriction, and
determine the power based on the one or more parameters,
wherein the transceiver is further configured to:
transmit the sensing signal based on i) the time domain pattern, ii) the determined spatial filter, and iii) the determined power, or
receive the sensing signal based on i) the time domain pattern, and ii) the determined spatial filter.

2. The UE of claim 1, wherein the transceiver is further configured to transmit assistance information for communication and the assistance information includes at least one of:
information related to a directional blockage, or
information related to a preferred beam direction for communication.

3. The UE of claim 1, wherein the information related to the sensing signal provides a reference signal type for sensing signals.

4. The UE of claim 1, wherein the information related to the sensing signal provides a reference signal type for sensing signals, and the reference signal type includes at least one of:
a signal based on a sounding reference signal (SRS), or
a signal based on a channel state information reference signal (CSI-RS).

5. The UE of claim 1, wherein the information related to the sensing signal provides information related to a length of a sequence of the sensing signal.

6. The UE of claim 1, wherein the time domain pattern comprises:
a first pattern defining first sensing occasions in a first time scale, and
a second pattern defining second sensing occasions in a second time scale within the first sensing occasions defined by the first pattern.

7. The UE of claim 1, wherein the spatial filter i) repeats over more than one sensing occasion, or ii) sweeps to different directions over more than one sensing occasion.

8. The UE of claim 1, wherein the one or more parameters related to the spatial filter directly indicates a single beam direction to be used to transmit or receive the sensing signal.

9. The UE of claim 1, wherein the one or more parameters related to the spatial filter provide assistance information to adjust the spatial filter to transmit or receive the sensing signal.

10. The UE of claim 1, wherein the one or more parameters related to the power provide at least one of:
an explicit indication on the power to transmit the sensing signal,
parameters used to determine the power to transmit the sensing signal, or
a transmission power control command indicating an increase or a decrease of the power to transmit the sensing signal.

11. A method performed by a user equipment (UE), the method comprising:
receiving information related to a sensing signal, the information including at least:
a time domain pattern to transmit or receive the sensing signal, and
one or more parameters related to:
a power to transmit the sensing signal, or
a spatial filter to transmit or receive the sensing signal;
determining the sensing signal based on the information;
determining the spatial filter based on the one or more parameters, wherein the one or more parameters at least provide information related to sensing beam restriction;
determining the power based on the one or more parameters; and
one of:
transmitting the sensing signal based on i) the time domain pattern, ii) the determined spatial filter, and iii) the determined power, or
receiving the sensing signal based on i) the time domain pattern, and ii) the determined spatial filter.

12. The method of claim 11, further comprising:
transmitting assistance information for communication, wherein the assistance information includes at least one of:
information related to a directional blockage, or
information related to a preferred beam direction for communication.

13. The method of claim 11, wherein the information related to the sensing signal provides a reference signal type for sensing signals.

14. The method of claim 11, wherein the information related to the sensing signal provides a reference signal type for sensing signals, and the reference signal type includes at least one of:
a signal based on a sounding reference signal (SRS), or
a signal based on a channel state information reference signal (CSI-RS).

15. The method of claim 11, wherein the information related to the sensing signal provides information related to a length of a sequence of the sensing signal.

16. The method of claim 11, wherein the time domain pattern comprises:
a first pattern defining first sensing occasions in a first time scale, and
a second pattern defining second sensing occasions in a second time scale within the first sensing occasions defined by the first pattern.

17. The method of claim 11, wherein the spatial filter i) repeats over more than one sensing occasion, or ii) sweeps to different directions over more than one sensing occasion.

18. The method of claim 11, wherein the one or more parameters related to the spatial filter directly indicates a single beam direction to be used to transmit or receive the sensing signal.

19. The method of claim 11, wherein the one or more parameters related to the spatial filter provide assistance information to adjust the spatial filter to transmit or receive the sensing signal.

20. The method of claim 11, wherein the one or more parameters related to the power provide at least one of:
an explicit indication on the power to transmit the sensing signal,
parameters used to determine the power to transmit the sensing signal, or
a transmission power control command indicating an increase or a decrease of the power to transmit the sensing signal.
